(19) United States
(12) Patent Application Publication
(10) Pub. No.: US 2017/0176582 A1
(43) Pub. Date: Jun. 22, 2017

(54) ULTRASOUND RANGING METHOD AND APPARATUS

(71) Applicant: Intel Corporation, Santa Clara, CA (US)

(72) Inventor: Ulf Bjorkengren, Bjarred (SE)

(21) Appl. No.: 14/977,123

(22) Filed: Dec. 21, 2015

(51) Int. Cl. G01S 11/16

(52) U.S. Cl. CPC G01S 11/16

(57) ABSTRACT

Between at least two devices, a base-line temporal reference is established by transmitting an electromagnet (“EM”) signal. At a different time, an ultrasound (“US”) signal is transmitted. A first off-set is determined between the base-line temporal reference and the US signal transmission time. A second off-set is determined between base-line temporal reference and the US signal reception time. The device which transmits the US signal also transmits the first off-set. Which device plays which role may be determined by the devices and the order of EM and US signal transmission may be varied.

### BACKGROUND

Ultrasound sensors are now found in smart phones, with proposed uses such as detecting gestures. Ultrasound sensors can also be used for distance measurements and in positioning use cases. Bluetooth® and other radio technologies (such as WiFi, cellular, etc.) are used to communicate and are used as components of beacons.

Ultrasound and radio technologies have been used to implement an in-door positioning system. For example, the “Cricket Indoor Location System” at the Massachusetts Institute of Technology combines ultrasound and radio technologies to provide “fine-grained location information”. The Cricket project, however, requires simultaneous transmission of ultrasound and radio signals and does not use a widely accepted radio standard, such as Bluetooth®. The Cricket project and/or other approaches also or alternatively require synchronized clocks between beacon and the receiver.

Requiring simultaneous transmission of ultrasound and radio signals and/or synchronized clocks limits the types of equipment which can be used to implement ultrasound ranging systems. An approach wherein the ultrasound and radio signals are transmitted separately, and an approach which does not require synchronized clocks, would allow a broad range of existing computer equipment to be used to implement an ultrasound ranging system, potentially with only a software upgrade.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating devices and signals in accordance with one embodiment.

FIG. 2 is a functional block diagram of an embodiment of Beacon 200.

FIG. 3 is a functional block diagram of an embodiment of Beacon Datastore.

FIG. 4 is a functional block diagram of an embodiment of Ultrasound Receiver 400.

FIG. 5 is a functional block diagram of an embodiment of Ultrasound Receiver Datastore.

FIG. 6 illustrates a first set of electromagnetic and ultrasound transmissions in accordance with one embodiment.

FIG. 7 illustrates a second set of electromagnetic and ultrasound transmissions in accordance with a second embodiment.

FIG. 8 illustrates a third set of electromagnetic and ultrasound transmissions in accordance with a third embodiment.

FIG. 9 is a flow chart illustrating an example of an embodiment of Start Session Module.

FIG. 10 is a flow chart illustrating an example of an embodiment of Signal Sorter Module.

FIG. 11 is a flow chart illustrating an example of Receiver ToF Module: EM Before US

FIG. 12 is a flow chart illustrating an example of Beacon ToF Module: EM Before US

FIG. 13 is a flow chart illustrating an example of Beacon ToF Module: EM After US Transmission, But Before US Reception.

FIG. 14 is a flow chart illustrating an example of Receiver ToF Module: EM After US Transmission, But Before US reception.

FIG. 15 is a flow chart illustrating an example of a module for Beacon ToF Module: EM after US Reception.

FIG. 16 is a flow chart illustrating an example of a module for Receiver ToF Module: EM After US Reception.

### DETAILED DESCRIPTION

A base-line temporal reference is established between at least two devices by transmission of an electromagnet (“EM”) signal. At a different time, an ultrasound (“US”) signal is transmitted. The base-line temporal reference may be sent before transmission of ultrasound signal, during transmission of ultrasound signal, or after reception of ultrasound signal.

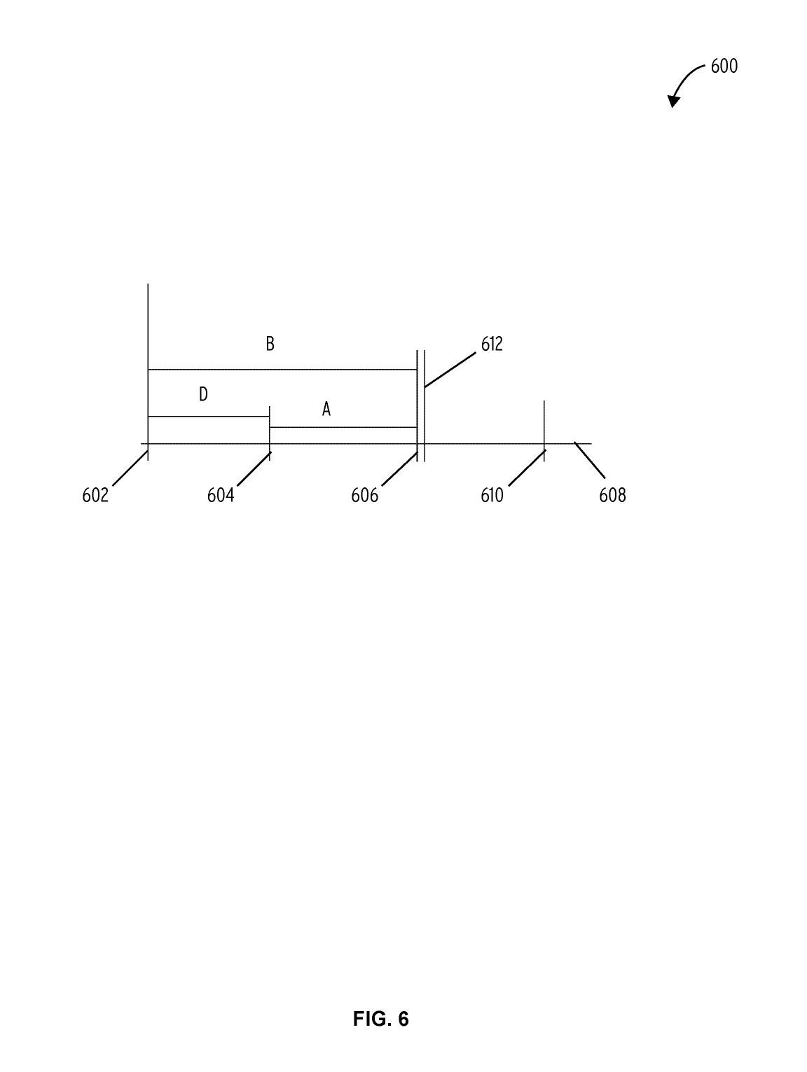

A first off-set is determined between the base-line temporal reference and the US signal transmission time, also referred to herein as US Transmit Off-Set 310. A second off-set is determined between base-line temporal reference and the US signal reception time, also referred to herein as US Receive Off-Set 514. Determination of these off-sets is made possible by a timer initiated relative to the EM signal. Due to requirements for precise time recordation, the devices may start timers upon reception of all EM signals, though may discard timers which are not needed. Correction for the difference in propagation speeds of the EM and US signals may be performed, but for practical implementations, the EM signal may be treated as being sent and received by the multiple devices at one simultaneous time. This correction is discussed further in relation to FIG. 6.

The first off-set is communicated by one device to the other; generally herein, Beacon 200 is described as determining and communicating the first off-set. The second off-set may be determined by the second device; generally herein, Ultrasound Receiver 400 is described as determining the second off-set. The second off-set does not need to be communicated to the other device. The two off-sets are used to determine a time-of-flight for the US signal. How this is determined depends on the order in which the signals are sent and received.

The US time-of-flight may be used to determine a distance between the source of the US signal and a receiver of the US signal. Generally herein, Beacon 200 is discussed as being the source of the US signal while the receive is discussed as being Ultrasound Receiver 400.

With multiple beacons, the distance determinations may be used to bi- or trilaterate positions of one or both the ultrasound transmitter and receiver. The positions may be relative (if the beacon positions are not known) or may be absolute (if the beacon positions are known).

For contexts including more than one range-finding session, the devices may identify a set of paired US and EM signals by identifiers included in or associated with the signals. Which device acts as a “beacon” or Beacon 200 and which acts as an “ultrasound receiver” or Ultrasound Receiver 400 may be determined by the devices; the order of EM and US signal transmission may also be varied. Multiple devices in close spatial and temporal proximity may interact in multiple range-finding sessions. At least one device in a range-finding session (typically the ultrasound receiver) may remain anonymous.

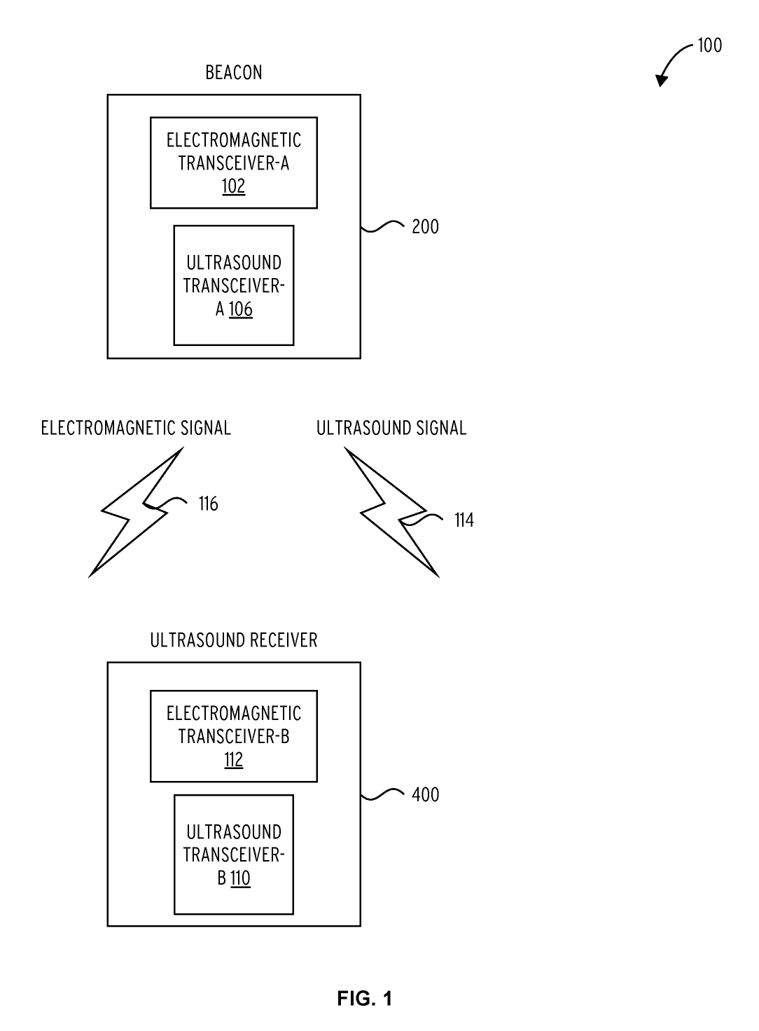

In FIG. 1, a Beacon 200 and an Ultrasound Receiver 400 are illustrated. The two devices are in fairly close proximity, such as within a room or another space within ultrasound transmission range; they must also be within range to transmit electromagnetic signals, but (with the possible exception of visible or infrared electromagnetic signals) that is typically a larger range than ultrasound transmission range.

Also illustrated are Electromagnetic Signal 116 and Ultrasound Signal 114. As discussed further herein, which device generates which signal may be determined dynamically. The signals may encode information, such as identifiers. The identifiers may be used by Beacon 200 and Ultrasound Receiver 400 and by modules executed by these devices (discussed further herein) to determine which signals are associated and the order in which a set of associated signals are transmitted.

Both Beacon 200 and Ultrasound Receiver 400 are illustrated as comprising an electromagnetic transceiver and an ultrasound transceiver. Beacon 200 is illustrated as comprising EM Transceiver-A 102 and US Transceiver-A 106. Ultrasound Receiver 400 is similarly illustrated as comprising EM Transceiver-B 112 and US Transceiver-B 110. The electromagnetic transceivers may, for example, emit (transmit) and receive electromagnetic radiation, whether in the radio, infra-red, visible, or other portion of the electromagnetic radiation spectrum. Examples of electromagnetic transceivers include Bluetooth®, WiFi, and LTE systems. The EM transceivers in both devices do not need to be the same, so long as each device can receive an EM signal emitted by the other. In an embodiment, Ultrasound Receiver 400 may comprise only an ultrasound receiver (it does not necessarily need to be able to transmit an ultrasound signal).

In general overview, a base-line temporal reference is established by transmission of an electromagnetic signal, such as Electromagnetic Signal 116. Either device may establish the base-line temporal reference. At a different time, an ultrasound (“US”) signal is transmitted. The base-line temporal reference may be established before, during, or after transmission of the ultrasound signal (“during” means that the base-line temporal reference is established after the transmission of the ultrasound signal, but before the ultrasound signal is received). A first off-set is determined between the base-line temporal reference and the ultrasound signal transmission time. The first off-set may be, for example, an amount of time between the ultrasound signal transmission time and the earlier or later establishment of the base-line temporal reference. A second off-set is determined between base-line temporal reference and the ultrasound signal reception time; as with the first off-set, the base-line temporal reference may be established before or after the ultrasound reception time. The device which transmits the ultrasound signal also determines and transmits the first off-set to the other device. Which device plays which role may be determined by the devices.

The time-of-flight of the ultrasound signal is determined by the device which receives (does not transmit) the ultrasound signal, based on the first off-set and the second off-set. Determination of the time-of-flight depends on the order in which the signals were transmitted. Based on the time-of-flight, the ultrasound receiver (or another device with access to this information) can determine the distance to the ultrasound transmitter. If more than one ultrasound transmitter is active, then the position of the devices can be bi- or trilaterated. If a location of at least one of the devices is known, then the location of other of the devices can be determined absolutely (relative to the known location).

More than one of each type of device may be present in an area. A second ultrasound receiver within the area may use a base-line temporal reference established between a first ultrasound transmitter and a first ultrasound receiver as well as an ultrasound signal transmitted by the first ultrasound transmitter, the base-line temporal reference, and a first off-set transmitted by the first ultrasound transmitter.

Because, as described in greater detail herein, establishment of the base-line temporal reference and transmission of the ultrasound signal can occur at separate times, a wide range of equipment and configurations can perform the disclosures described herein, without expensive and often proprietary linkage between transmission of the ultrasound signal and transmission of the electromagnetic signal.

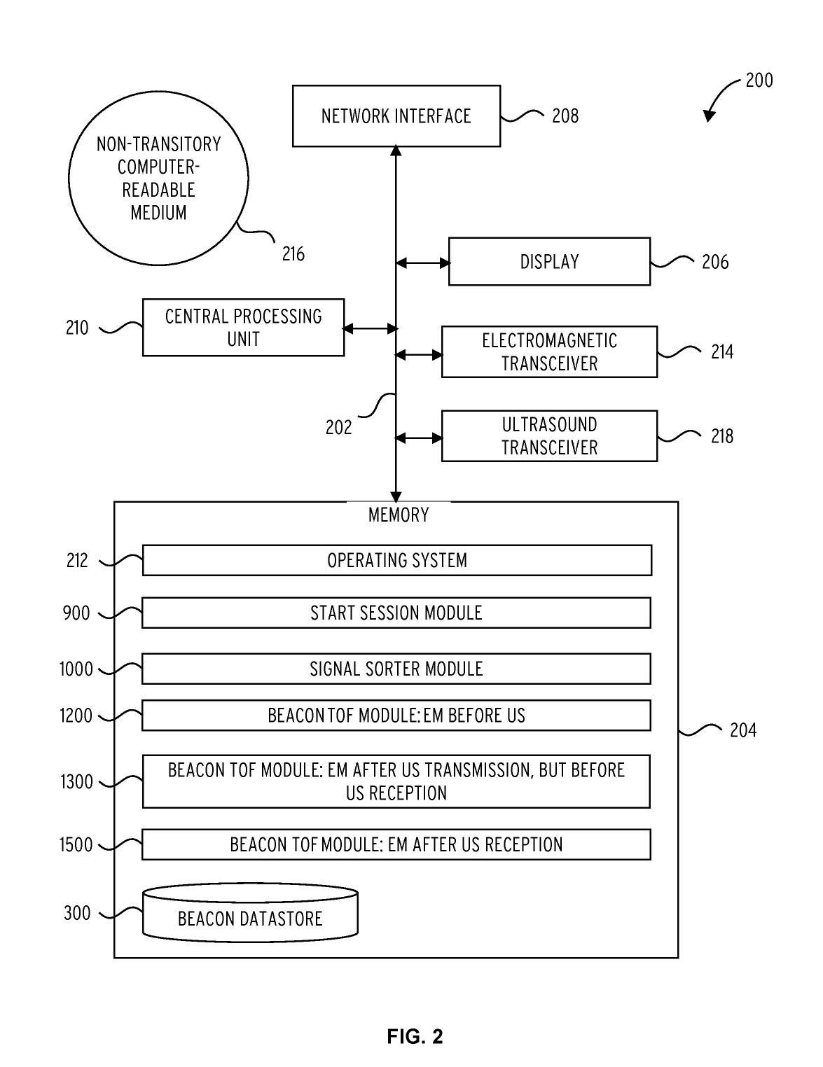

FIG. 2 illustrates several components of an exemplary Beacon 200 in accordance with one embodiment. In various embodiments, Beacon 200 may include or be a WiFi base station, a cellular telephone base station such as an E-UTRAN Node B (possibly in combination with a Radio Network Controller), or a desktop PC, server, workstation, mobile phone, laptop, tablet, set-top box, appliance, or other computing device that includes suitable hardware discussed herein, such as WiFi and Bluetooth® hardware, and is capable of performing operations such as those described herein. In some embodiments, Beacon 200 may include many more components than those shown in FIG. 2. However, it is not necessary that all of these generally conventional components be shown in order to disclose an illustrative embodiment.

In various embodiments, Beacon 200 may comprise one or more physical and/or logical devices that collectively provide the functionalities described herein. In some embodiments, Beacon 200 may comprise one or more replicated and/or distributed physical or logical devices.

In some embodiments, Beacon 200 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Beacon 200 includes Bus 202 interconnecting several components including Network Interface 208, Display 206, Central Processing Unit 210, Memory 204, Electromagnetic Transceiver 214, and Ultrasound Transceiver 218. Electromagnetic Transceiver 214, and Ultrasound Transceiver 218 may also connect via Network Interface 208, rather than via Bus 202. In various embodiments, Bus 202 may comprise a storage area network (“SAN”), a high speed serial bus, and/or via other suitable communication technology.

Memory 204 generally comprises a random access memory (“RAM”) and permanent non-transitory mass storage device, such as a hard disk drive or solid-state drive. Memory 204 stores Operating System 212, Start Session Module 900, Signal Sorter Module 1000, Beacon ToF Module: EM Before US 1200, Beacon ToF Module: EM After US Transmission, But Before US Reception 1300, and Beacon ToF Module: EM after US Reception 1500.

These and other software components may be loaded into Memory 204 of Beacon 200 using a drive mechanism (not shown) associated with a non-transitory computer-readable medium 216, such as a floppy disc, tape, DVD/CD-ROM drive, memory card, or the like.

Memory 204 also includes Beacon Datastore 300. In some embodiments, Beacon 200 may communicate with Beacon Datastore 300 via Network Interface 208, a storage area network (“SAN”), a high-speed serial bus, and/or via the other suitable communication technology.

In some embodiments, Beacon Datastore 300 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

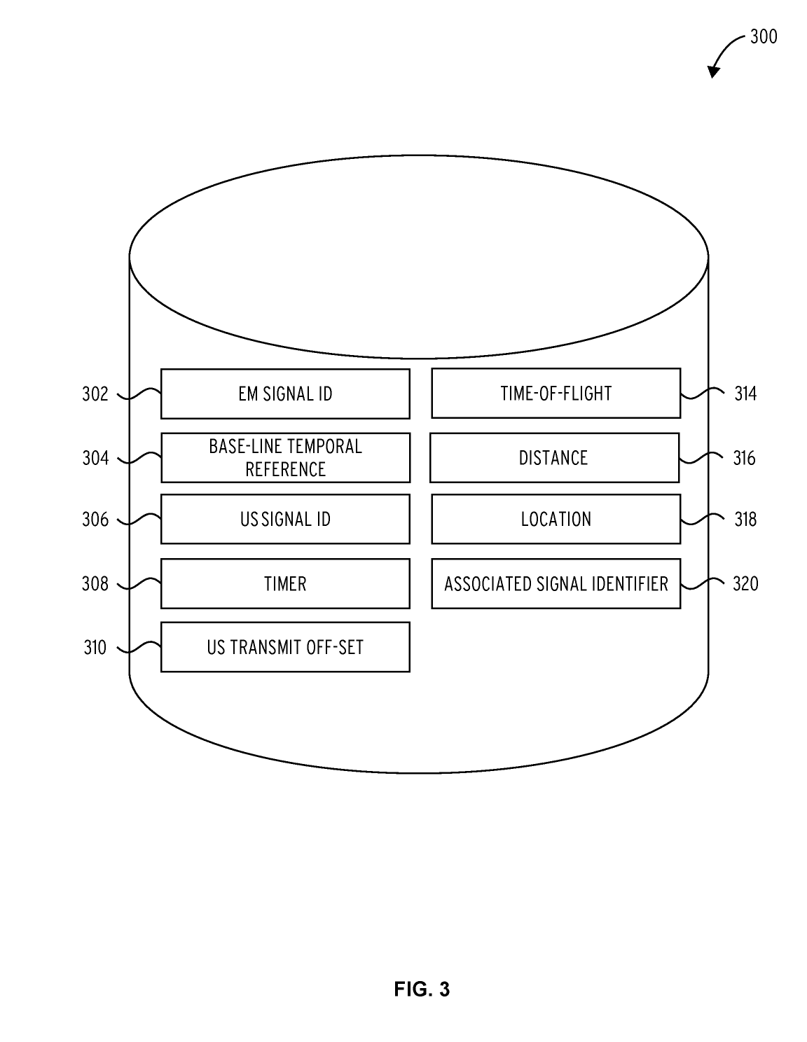

In relation to FIG. 3, the illustrated components of Beacon Datastore 300 are data groups used by Modules and are discussed further herein in the discussion of other of the Figures.

The data groups used by routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar.

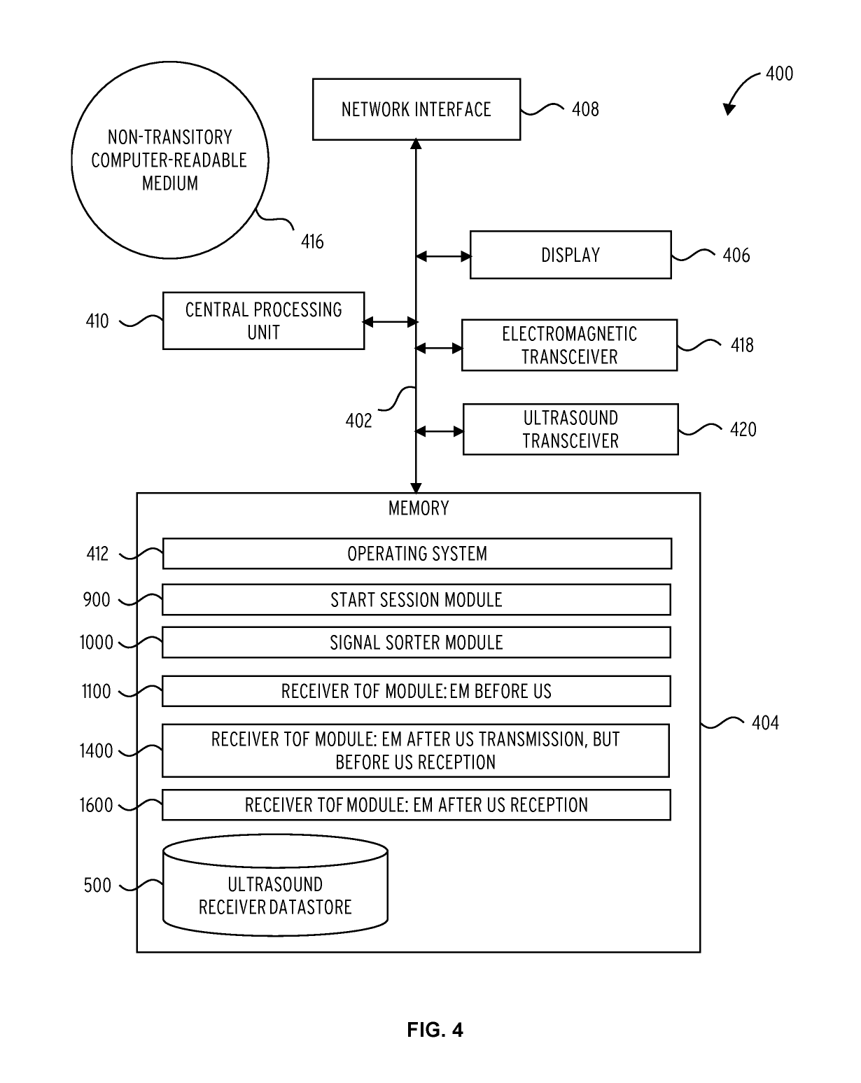

FIG. 4 illustrates several components of an exemplary Ultrasound Receiver 400 in accordance with one embodiment. In various embodiments, Ultrasound Receiver 400 may include a WiFi base station, a cellular telephone base station such as an E-UTRAN Node B (possibly in combination with a Radio Network Controller), or a desktop PC, server, workstation, mobile (cellular) phone, laptop, tablet, set-top box, appliance, or other computing device that includes suitable hardware discussed herein, such as WiFi and Bluetooth® hardware, and is capable of performing operations such as those described herein. In some embodiments, Ultrasound Receiver 400 may include many more components than those shown in FIG. 4. However, it is not necessary that all of these generally conventional components be shown in order to disclose an illustrative embodiment.

In various embodiments, Ultrasound Receiver 400 may comprise one or more physical and/or logical devices that collectively provide the functionalities described herein. In some embodiments, Ultrasound Receiver 400 may comprise one or more replicated and/or distributed physical or logical devices.

In some embodiments, Ultrasound Receiver 400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Ultrasound Receiver 400 includes Bus 402 interconnecting several components including Network Interface 408, Display 406, Central Processing Unit 410, Memory 404, Electromagnetic Transceiver 418, and Ultrasound Transceiver 420. Electromagnetic Transceiver 418 and Ultrasound Transceiver 420 may also connect via Network Interface 408, rather than via Bus 402. In various embodiments, Bus 402 may comprise a storage area network (“SAN”), a high speed serial bus, and/or via other suitable communication technology.

Memory 404 generally comprises a random access memory (“RAM”) and permanent non-transitory mass storage device, such as a hard disk drive or solid-state drive. Memory 404 stores Operating System 212, Start Session Module 900, Signal Sorter Module 1000, Receiver ToF Module: EM before US 1100, Receiver ToF Module: EM After US Transmission, But Before US Reception 1400, and Receiver ToF Module: EM After US Reception 1600.

These and other software components may be loaded into Memory 404 of Ultrasound Receiver 400 using a drive mechanism (not shown) associated with a Non-Transitory Computer-Readable Medium 416, such as a floppy disc, tape, DVD/CD-ROM drive, memory card, or the like.

Memory 404 also includes Ultrasound Receiver Datastore 500. In some embodiments, Ultrasound Receiver 400 may communicate with Ultrasound Receiver Datastore 500 via Network Interface 408, a storage area network (“SAN”), a high-speed serial bus, and/or via the other suitable communication technology.

In some embodiments, Ultrasound Receiver Datastore 500 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

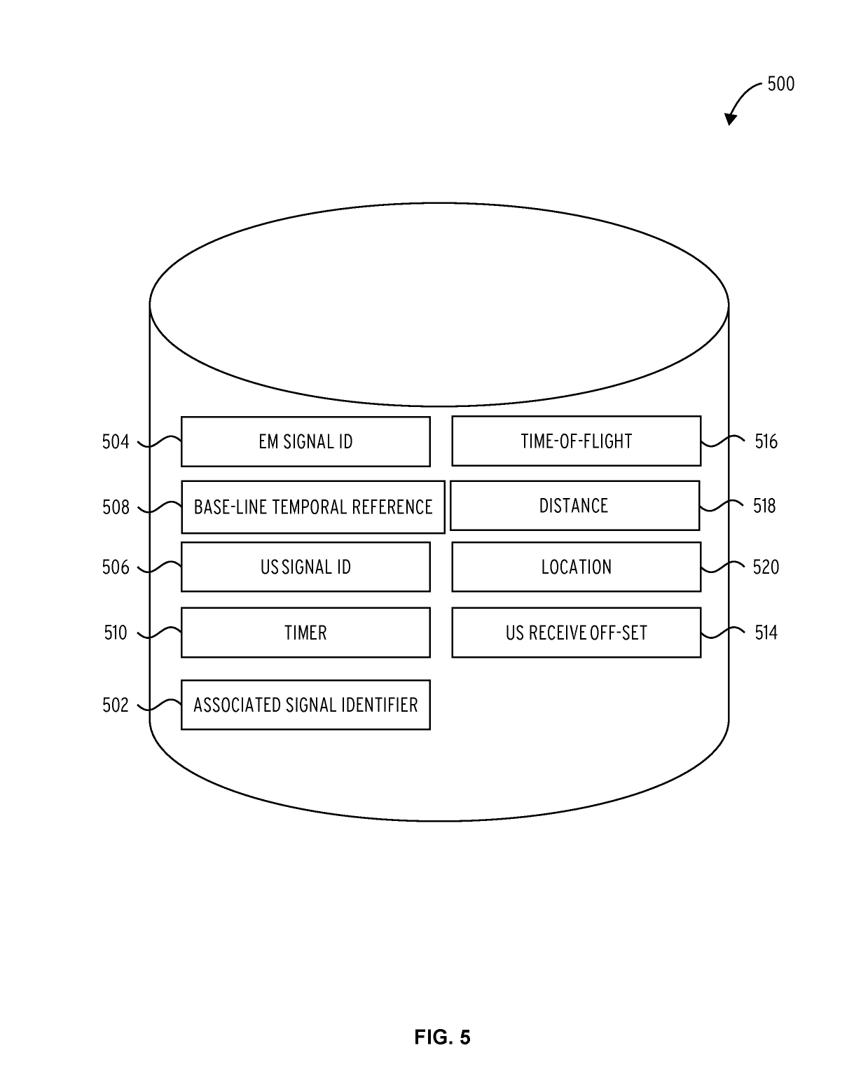

In relation to FIG. 5, the illustrated components of Ultrasound Receiver Datastore 500 are data groups used by Modules and are discussed further herein in the discussion of other of the Figures.

The data groups used by routines illustrated in FIG. 5 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar.

FIG. 6 to FIG. 8 illustrate the order in which electromagnetic and ultrasound signals can be sent and received in accordance with different embodiments. Devices embodying this disclosure, such as Beacon 200 and Ultrasound Receiver 400, can be configured to use one signal order embodiment or, as discussed further herein, the devices can be configured to use more than one signal order embodiment. Devices embodying this disclosure may have synchronized clocks, such as clocks synchronized to an atomic clock; however, the devices do not need to have synchronized clocks, as it is more expensive and technically difficult to deploy devices with synchronized clocks, and clock synchronization is not required. In FIG. 6, item 608 indicates the progression of time.

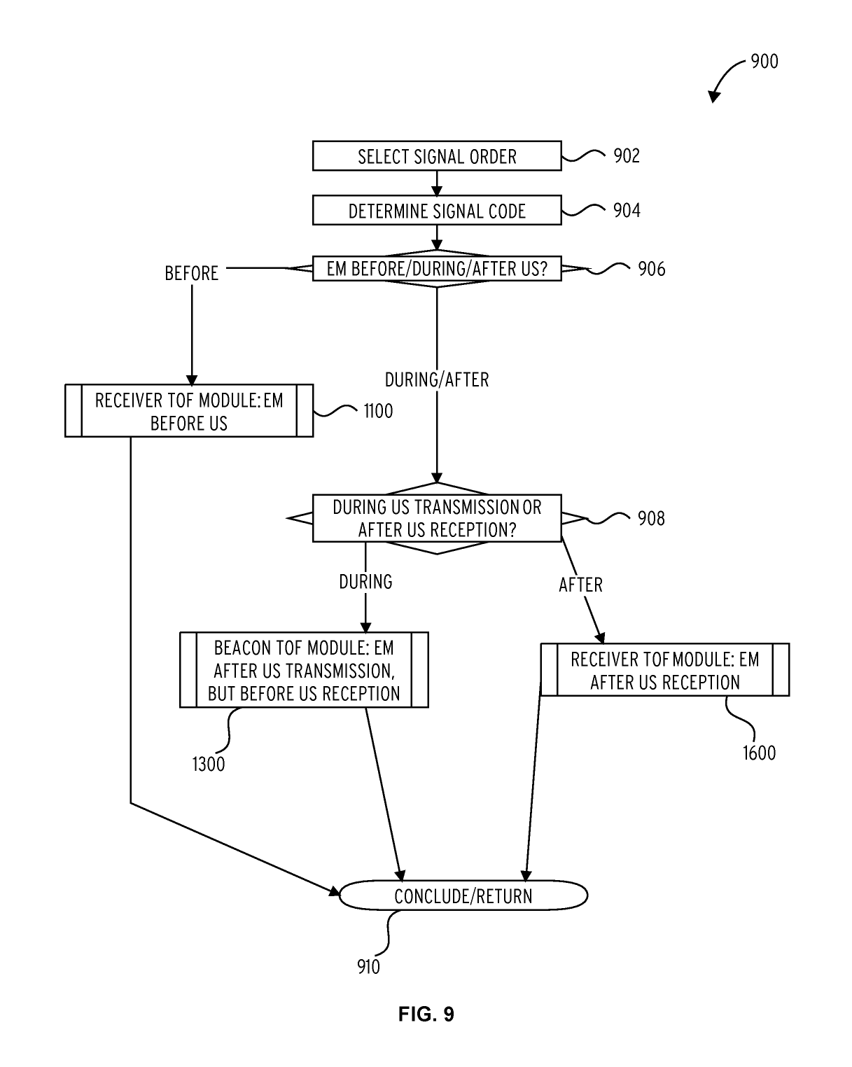

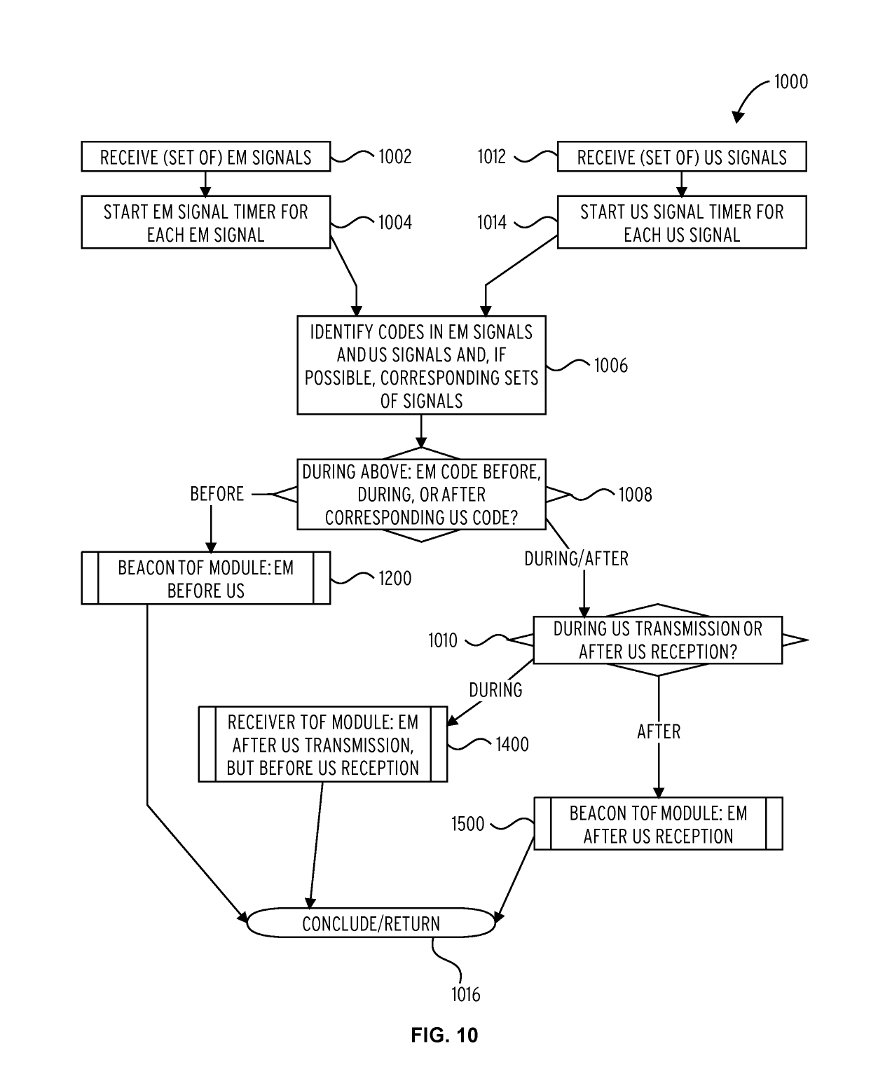

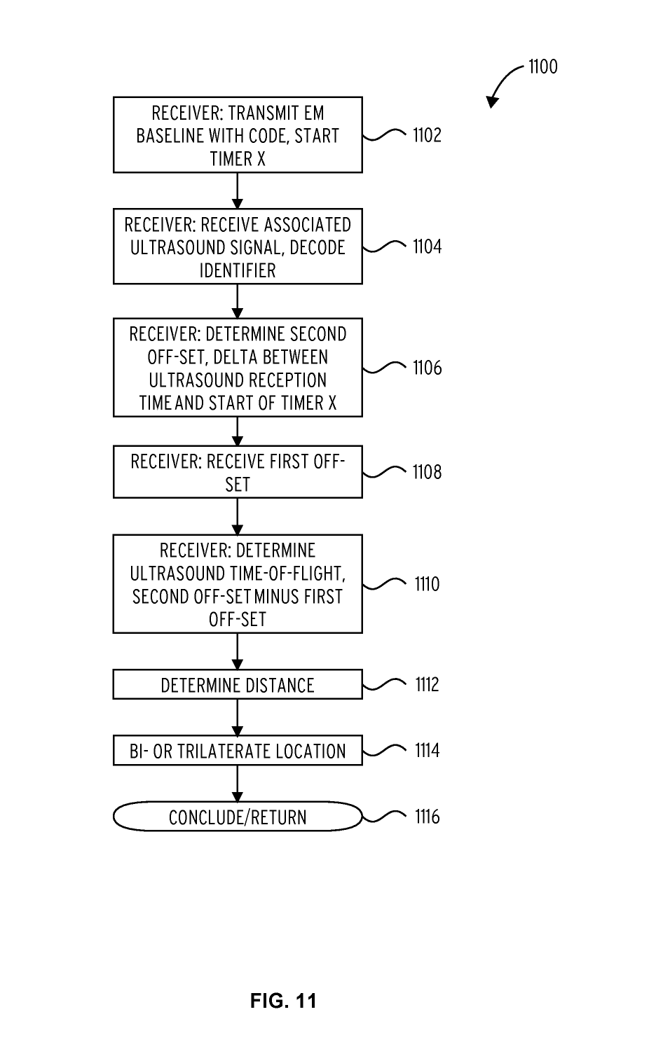

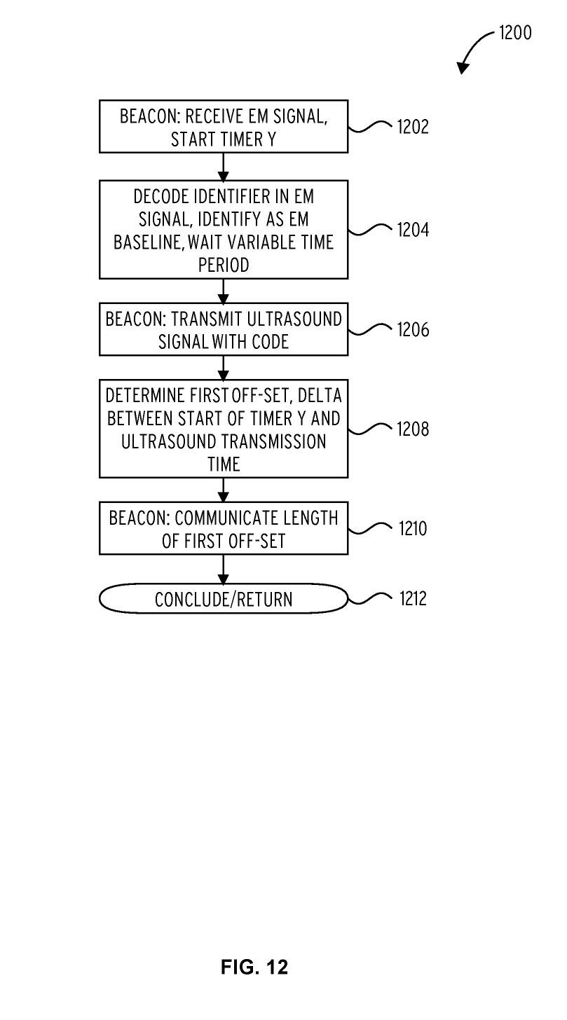

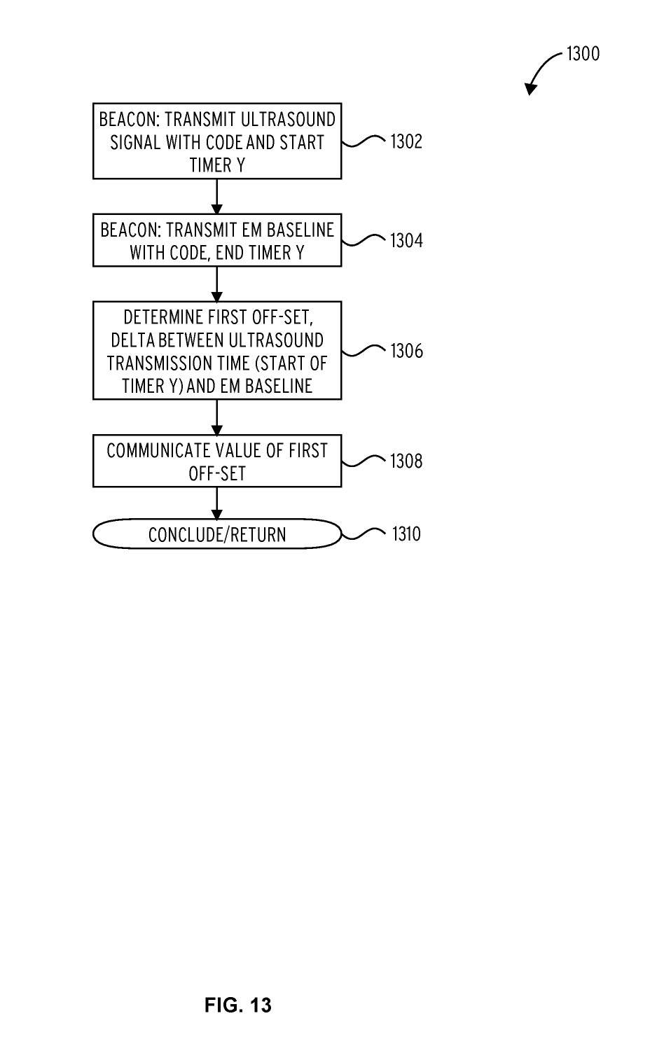

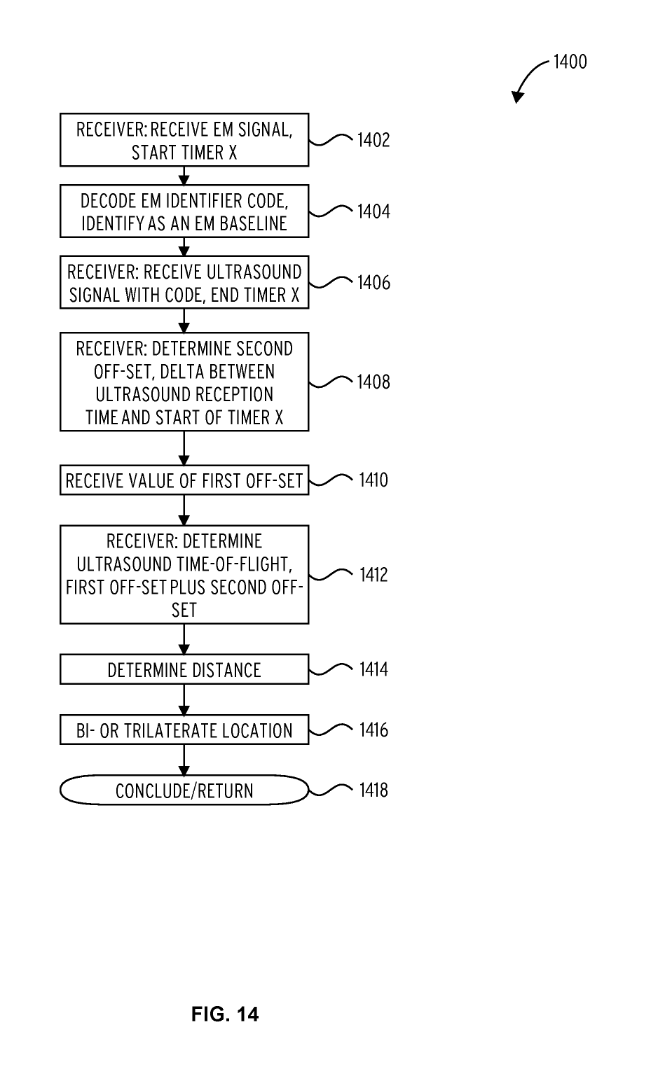

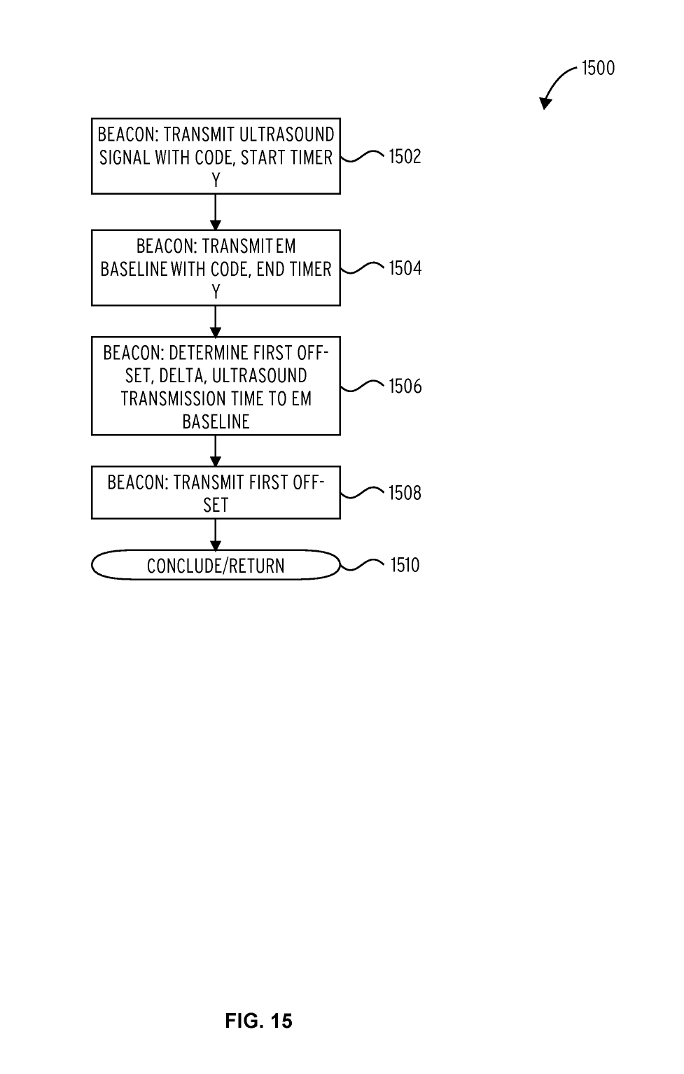

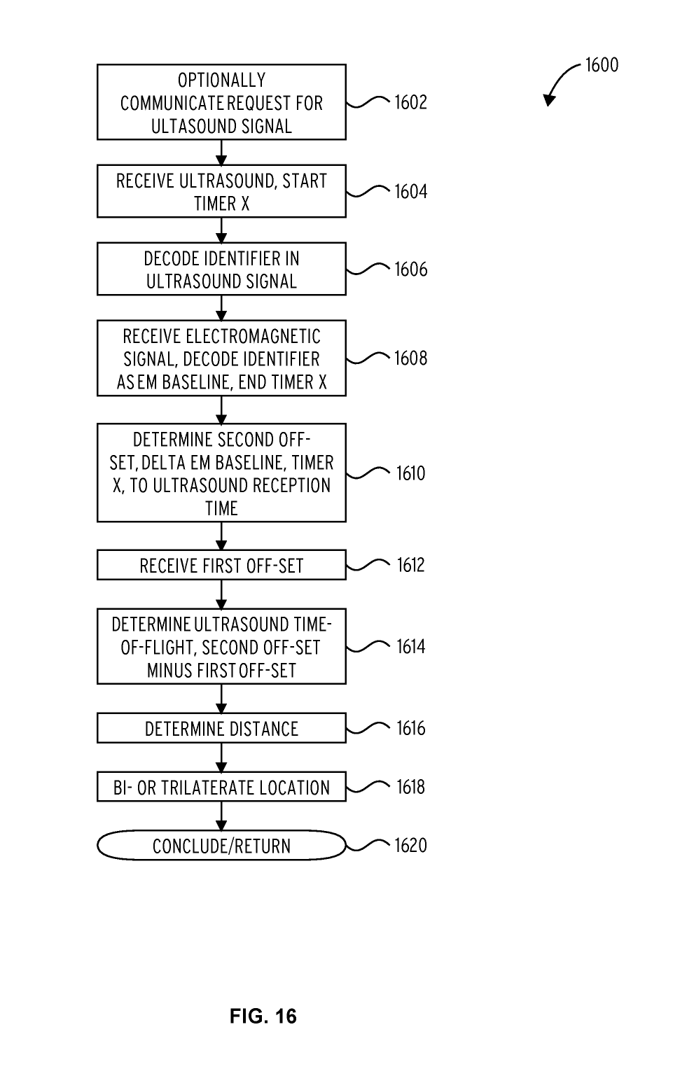

In FIG. 6 to FIG. 8, discussion is with respect to Beacon 200 and Ultrasound Receiver 400; it should be understood that this discussion also indicates that these devices are executing the modules in their respective memories and that the actions are being performed by the modules discussed in greater detail in relation to FIG. 9 to FIG. 16.

In FIG. 6 to FIG. 8, “A” is a span of time between the base-line temporal reference and the ultrasound reception time, also referred to herein as a second off-set; “B” is a span of time between the base-line temporal reference and a time of transmission of an ultrasound signal, also referred to herein as a first off-set; “D” is the “time-of-flight” of an ultrasound signal (time-of-flight is the amount of time between transmission and reception of the signal). The spans of time in the off-sets may be positive or negative; the base-line temporal reference may precede or follow the other event.

If FIG. 6, at ultrasound transmission time 602, Beacon 200 transmits an ultrasound signal. Ultrasound Receiver 400 does not necessarily “know” that Beacon 200 has transmitted an ultrasound signal. In addition, a base-line temporal reference has not yet been established. Transmission of an ultrasound signal by Beacon 200 may have been preceded by a request by Ultrasound Receiver 400 for an ultrasound signal or an announcement by Beacon 200 that it was going to transmit an ultrasound signal. Such a request or announcement, if it occurs at all, does not need to occur at a particular time or use a particular media (such as electromagnetic spectrum). Transmission of ultrasound signal may be triggered by, for example, Beacon 200 being made aware that a device, a person, etc., is within reception range, such as according to a motion detector.

At ultrasound reception time 604, Ultrasound Receiver 400 receives the ultrasound signal transmitted by Beacon 200 and starts a clock-counter or “timer” which runs until when Beacon 200 or Ultrasound Receiver 400 transmits, at item 606, an electromagnetic signal to establish a base-line temporal reference. As discussed elsewhere, due to precise timing requirements, timers may be started for each new ultrasound signal and electromagnetic signal, with unused timers being discarded.

At item 606, Ultrasound Receiver 400 receives the electromagnetic signal which establishes base-line temporal reference. In FIG. 6, the electromagnetic signal which signals establishment of base-line temporal reference is transmitted by Beacon 200. When or just prior to when Beacon 200 transmits the electromagnetic signal establishing the base-line temporal reference, Beacon 200 also determines how much time has elapsed since transmission of the ultrasound signal at ultrasound transmission time 602, which in this Figure is first off-set. Being strict, this electromagnetic signal is not received by Ultrasound Receiver 400 at item 606, but is received slightly later, at item 612 (the difference between item 606 and item 612 being the time-of-flight of the electromagnetic signal). However, because electromagnetic radiation propagates approximately one million times faster than ultrasound signals, and because the devices must be within ultrasound reception range, the difference between item 606 and item 612 may be ignored, and the devices may treat establishment of the base-line temporal reference as occurring at the same time in the multiple devices.

The electromagnetic signal which signals establishment of the base-line temporal reference may also communicate the length of time in first off-set. However, this is optional. Alternatively, first off-set may be communicated at another time and via other media (whether wireline, wireless, electromagnetic, ultrasound, etc.), such as at first off-set communication time 610. The first off-set may be relayed between Ultrasound Receiver 400 and Beacon 200 via another device or module.

As discussed further herein, after ultrasound reception time 604 (and potentially later, such as after first off-set communication time 610), Ultrasound Receiver 400 determines the span of time between the ultrasound reception time 604 and the base-line temporal reference, the second off-set, and uses first off-set and second off-set to determine the time-of-flight of the ultrasound signal, such as by subtracting second off-set from first off-set.

In all of FIG. 6 through FIG. 8, the time-of-flight of the ultrasound signal may be used by Ultrasound Receiver 400 (or another device with access to this information) to determine the distance between Ultrasound Receiver 400 and Beacon 200. If more than one Beacon 200 is active, then the position of the Ultrasound Receiver 400 can be bi- or trilaterated, relative to the transmitters (or visa versa). If a location of at least one of the devices is known, then the location of the other devices can be determined absolutely, relative to the known location.

FIG. 6 also illustrates item 612, which may be understood as the time-of-flight for the electromagnetic signal which established the base-line temporal reference. Being strict, the first off-set in FIG. 6, the span of time represented by letter “B”, contains Beacon 200's measurement of the span of time between when ultrasound signal was sent and when the base-line temporal reference was established by transmission of an electromagnetic signal.

Being strict, determination of the time-of-flight of the ultrasound signal may be as follows: B, plus the time-of-flight of electromagnetic signal, minus A, which can also be determined as (B minus A) divided by (1 minus (ultrasound signal velocity divided by electromagnetic signal velocity)). However, and as noted above, (ultrasound signal velocity divided by electromagnetic signal velocity) approaches zero for the circumstances discussed herein.

Thus, in FIG. 6, ultrasound signal transmission time is before establishment of the base-line temporal reference by transmission of an electromagnetic signal at item 606 and the base-line temporal reference is established after reception of the ultrasound signal (which occurred at item 604).

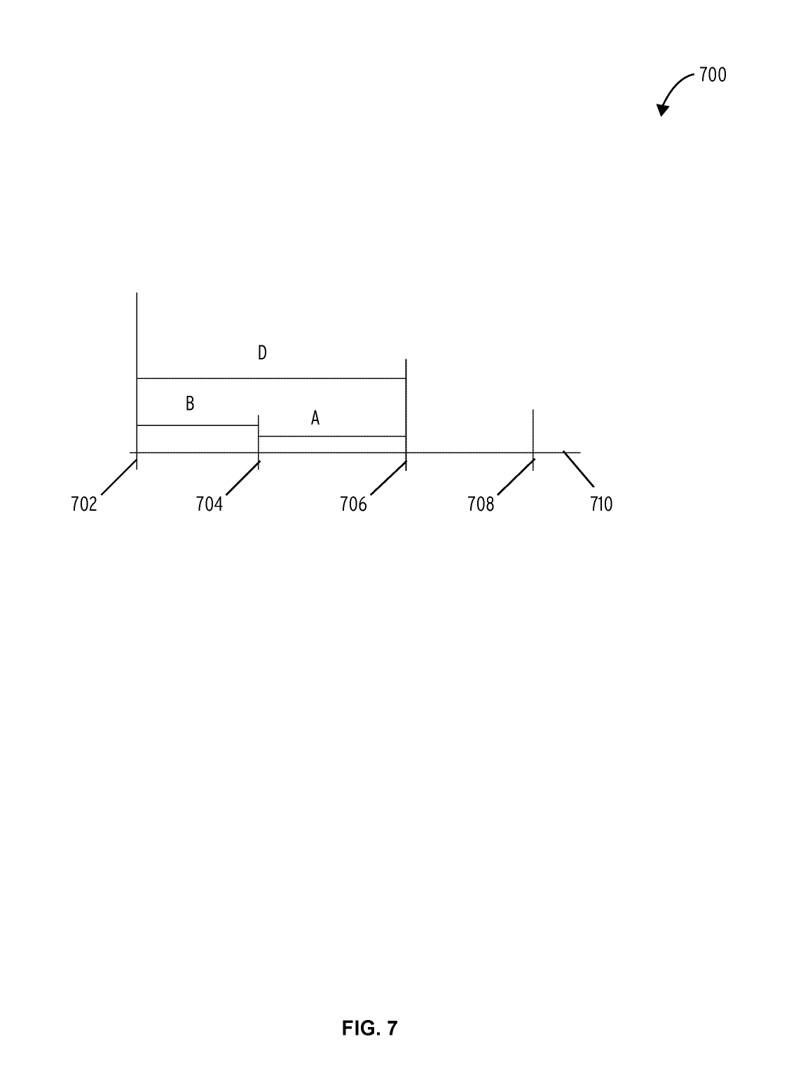

In FIG. 7, the electromagnetic signal which establishes the base-line temporal reference is sent during the time-of-flight of the ultrasound signal, but before reception of the ultrasound signal.

At ultrasound transmission time 702, Beacon 200 transmits an ultrasound signal. At ultrasound transmission time 702, Beacon 200 also starts a timer to measure the span of time between ultrasound transmission time 702 and establishment of base-line temporal reference, also referred to herein as the first off-set.

Ultrasound Receiver 400 does not necessarily “know” that Beacon 200 has transmitted an ultrasound signal. In addition, a base-line temporal reference has not yet been established. As before, transmission of the ultrasound signal by Beacon 200 may have been preceded by a request by Ultrasound Receiver 400 for an ultrasound signal or an announcement by Beacon 200 that it was going to transmit an ultrasound signal. As before, such a request or announcement, if it occurs at all, does not need to occur at a particular time or use a particular media (such as electromagnetic spectrum). As before, transmission of ultrasound signal may be triggered by, for example, Beacon 200 being made aware that a device, a person, etc., is within reception range.

At item 704 along the timeline indicated by item 710, Beacon 200 transmits and Ultrasound Receiver 400 receives an electromagnetic signal which establishes a base-line temporal reference. As noted elsewhere (such as in relation to item 612 in FIG. 6), there may be a period of time between transmission and reception of this electromagnetic signal, but this period of time is short enough that it may be ignored. Upon reception of the electromagnetic signal establishing base-line temporal reference, Ultrasound Receiver 400 starts a timer which measures the span of time until ultrasound reception time 706, which is when Ultrasound Receiver 400 receives the ultrasound signal which was transmitted at ultrasound transmission time 702.

Following ultrasound reception time 706, Ultrasound Receiver 400 determines the span of time which occurred between base-line temporal reference and ultrasound reception time 706. As in relation to the other Figures herein, this is called a second off-set.

At item 708, Beacon 200 communicates to Ultrasound Receiver 400 the span of time between ultrasound transmission time 702 and establishment of base-line temporal reference at item 704. As in relation to the other Figures herein, this is referred to herein a first off-set. First off-set may be communicated at another time and via other media (whether wireline, wireless, electromagnetic, ultrasound, etc.). The first off-set may be relayed between Ultrasound Receiver 400 and Beacon 200 via another device or module.

Following receipt of first off-set from Beacon 200, Ultrasound Receiver 400 uses first off-set and second off-set to determine the time-of-flight of the ultrasound signal, such as by adding second off-set and first off-set.

In all of FIG. 6 through FIG. 8, the time-of-flight of the ultrasound signal may be used by Ultrasound Receiver 400 (or another device with access to this information) to determine the distance to Beacon 200. If more than one Beacon 200 is active, then the location of Ultrasound Receiver 400 can be bi- or trilaterated, relative to the transmitters. If a location of at least one of the ultrasound transmitting devices is known, then the location of the ultrasound receiver can be determined absolutely.

Thus, in FIG. 7, ultrasound signal transmission time is before establishment of the base-line temporal reference by transmission of an electromagnetic signal at item 704 and the base-line temporal reference is established before reception of the ultrasound signal.

Because establishment of base-line temporal reference and transmission of ultrasound signal can occur at separate times, a wide range of equipment and configurations can perform the disclosures described herein, without expensive and often proprietary linkage between transmission of an ultrasound signal and transmission of an electromagnetic signal.

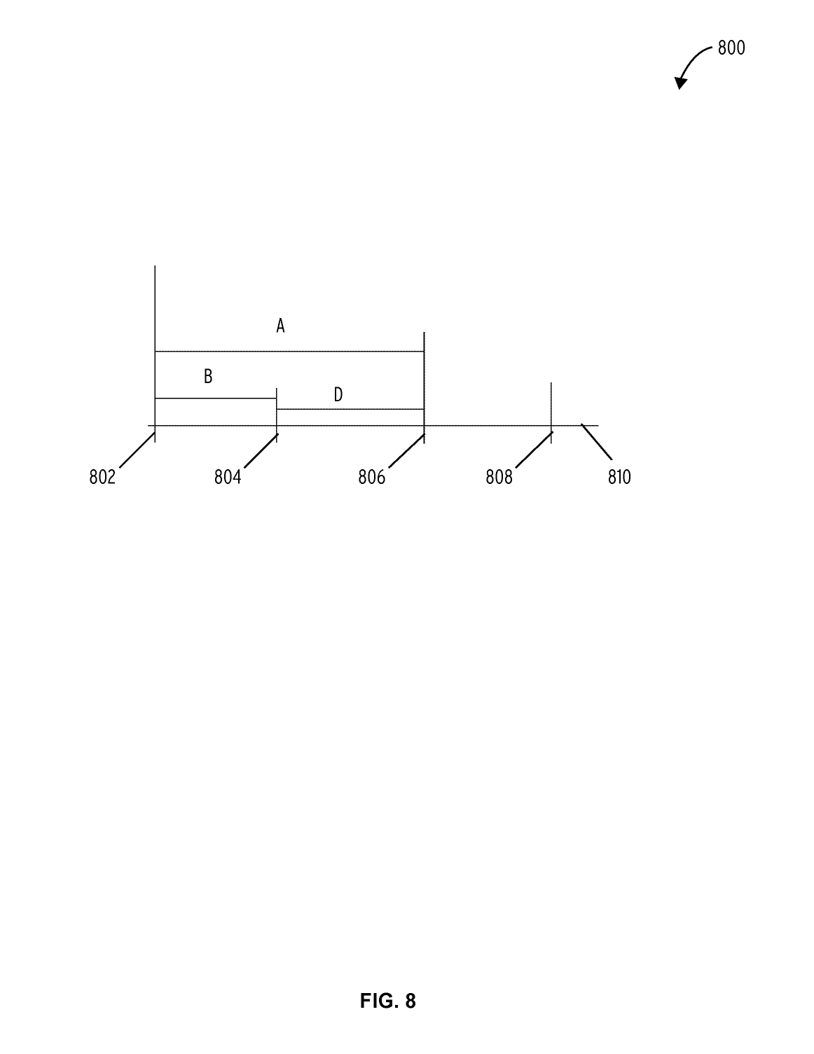

If FIG. 8, the electromagnetic signal which establishes the base-line temporal reference is sent before transmission of the ultrasound signal.

At item 802 on timeline 810, either Beacon 200 or Ultrasound Receiver 400 (or another proximate device) establish a base-line temporal reference by transmitting an electromagnetic signal.

At item 802, upon establishment of base-line temporal reference, Beacon 200 starts a timer to measure the span of time between base-line temporal reference and ultrasound transmission time 804, referred to herein as first off-set.

At item 802, upon establishment of base-line temporal reference, Ultrasound Receiver 400 starts a timer to measure the span of time between base-line temporal reference and ultrasound reception time 806, referred to herein as second off-set.

At ultrasound transmission time 804, Beacon 200 transmits an ultrasound signal and concludes measuring the span of time between establishment of base-line temporal reference (at item 802) and ultrasound transmission time 804. At this time, Ultrasound Receiver 400 has not yet received the ultrasound signal and may not know that one has been transmitted.

At ultrasound reception time 806, Ultrasound Receiver 400 receives the ultrasound signal and determines the span of time between base-line temporal reference (at item 802) and ultrasound reception time 806, also referred to herein as second off-set.

At item 808, Beacon 200 communicates first off-set to Ultrasound Receiver 400. First off-set may be communicated via other media (whether wireline, wireless, electromagnetic, ultrasound, etc.). The first off-set may be relayed between Ultrasound Receiver 400 and Beacon 200 via another device or module.

Following receipt of first off-set from Beacon 200, Ultrasound Receiver 400 uses first off-set and second off-set to determine the time-of-flight of the ultrasound signal, such as by subtracting first off-set from second off-set.

In all of FIG. 6 through FIG. 8, the time-of-flight of the ultrasound signal may be used by Ultrasound Receiver 400 (or another device with access to this information) to determine the distance between Ultrasound Receiver 400 and Beacon 200. If more than one Beacon 200 is active, then the position of Ultrasound Receiver 400 can be bi- or trilaterated, relative to the transmitters. If a location of at least one of the ultrasound transmitting devices is known, then the location of the ultrasound receiver can be determined absolutely.

Thus, in FIG. 8, ultrasound signal transmission time is after establishment of the base-line temporal reference.

Because establishment of base-line temporal reference and transmission of ultrasound signal can occur at separate times, a wide range of equipment and configurations can perform the disclosures described herein, without expensive and often proprietary linkage between transmission of an ultrasound signal and transmission of an electromagnetic signal.

Start Session Module 900 may be executed by either Beacon 200 or Ultrasound Receiver 400. Start Session Module 900 may be used by a device which is instructed to or otherwise begins a time-of flight ultrasound ranging session.

At block 902, Start Session Module 900 selects a signal order, such as whether Electromagnetic Signal 116 which is to set Base-Line Temporal Reference 304 will occur before or after a corresponding Ultrasound Signal 114, if after, whether Electromagnetic Signal 116 will be transmitted during transmission of Ultrasound Signal 114 (which is to say, before anticipated reception of Ultrasound Signal 114), or whether Electromagnetic Signal 116 will be transmitted after anticipated reception of Ultrasound Signal 114. This selection may be programmed in advance, may be provided by user selection, or may be selected according to an external factor, such as an environmental variable, such as an average distance between Beacon 200 and Ultrasound Receiver 400.

At block 904. Start Session Module 900 may determine a code or identifier to associate a set of electromagnetic and ultrasound signals, such that the other party can determine that i) an ultrasound ranging session has started and ii) which of many signals are associated. The determined code may be stored as, for example, Associated Signal Identifier 320 or Associated Signal Identifier 502 (depending on which device determines the code). The code may be formed according to a format or structure used by Beacon 200 and Ultrasound Receiver 400. Codes may be linked into corresponding sets, such that an EM Signal ID is expected to be accompanied by a corresponding US Signal ID (whether through numerical and/or logical correspondence).

At decision block 906, Start Session Module 900 may determine whether Electromagnetic Signal 116 which sets base-line temporal reference is to precede or follow a corresponding ultrasound signal. This determination may be programmed in advance, may be provided by user selection, or may be selected according to an external factor, such as an environmental variable, such as an average distance between Beacon 200 and Ultrasound Receiver 400.

If at decision block 906, the decision was to set base-line temporal reference before a corresponding ultrasound signal, then Start Session Module 900 may execute Receiver ToF Module: EM before US 1100.

If the determination at decision block 906 was “after”, then at decision block 908 a determination may be made regarding whether the base-line temporal reference will be established during the ultrasound signal transmission or after reception of the ultrasound signal. If during, then Start Session Module 900 will execute Beacon ToF Module: EM After US Transmission, But Before US Reception 1300. If after, then Start Session Module 900 will execute Receiver ToF Module: EM After US Reception 1600 will be executed as a subroutine.

At done block 910, Start Session Module 900 may conclude, return to its beginning, or return to a process which may have spawned it.

Signal Sorter Module 1000 is used by either Beacon 200 or Ultrasound Receiver 400 to receive electromagnetic and ultrasound signals, to identify codes or other information in the signals, to use the codes or identifiers to determine what signals are associated and the order the signals were sent in, and to use the order of the signals to determine which Time-of Flight Module to use to determine the time-of-flight of the ultrasound signal in a ranging session. In various embodiments, which Time-of Flight Module to use may be programmed in advance and may not be a variable.

block 1002 and block 1004 do not necessarily precede or follow block 1012 and block 1014.

As discussed in relation to this figure an electromagnetic signal, such as Electromagnetic Signal 116, establishes a base-line temporal reference.

At block 1002, Signal Sorter Module 1000 receives one or more electromagnetic signals, such as Electromagnetic Signal 116, which Electromagnetic Signal 116 may comprise an identifier or code determined by, for example Start Session Module 900.

At block 1004, Signal Sorter Module 1000 may start a timer for each Electromagnetic Signal 116 received at block 1002. Not all such timers may be required or may be used; unnecessary or unused timers may be ignored or discarded. Determination regarding whether a timer may be ignored or discarded may occur at a later time, such as after a window of time beyond which the timer could potentially be used.

At block 1012, Signal Sorter Module 1000 receives one or more ultrasound signals, such as Ultrasound Signal 114, which Ultrasound Signal 114 may comprise an identifier or code determined by, for example Start Session Module 900.

At block 1014, Signal Sorter Module 1000 may start a timer for each Ultrasound Signal 114 received at block 1012. Not all such timers may be required or may be used; unnecessary or unused timers may be ignored or discarded. Determination regarding whether a timer may be ignored or discarded may occur at a later time, such as after a window of time beyond which the timer could potentially be used.

At block 1006, Signal Sorter Module 1000 may identify the codes or identifiers in each Electromagnetic Signal 116 and Ultrasound Signal 114. The identified codes may be stored as, for example, EM Signal ID 302, EM Signal ID 504, US Signal ID 306, or US Signal ID 506, depending on which device is executing Signal Sorter Module 1000. Codes may be linked into corresponding sets, such that an EM Signal ID is expected to be accompanied by a corresponding US Signal ID (whether through numerical and/or logical correspondence). Identification of corresponding codes may not always be possible, as may be the case when block 1006 is executed before all signals in a set have been received. Absence of a code may be used as an indicator of code order.

At decision block 1008, which may occur during the blocks above it, a decision may be made regarding the order in which a set of associated signals are received.

If it is decided at decision block 1008 that Electromagnetic Signal 116 is received before a corresponding Ultrasound Signal 114, which may be determined when an EM Signal ID is received before a corresponding or expected US Signal ID or after receipt of both signals in this order, then Signal Sorter Module 1000 may execute Beacon ToF Module: EM Before US 1200.

If it is decided at decision block 1008 that Electromagnetic Signal 116 is during transmission of a corresponding Ultrasound Signal 114 or after receipt of a corresponding Ultrasound Signal 114, which may be determined when a US Signal ID is received after a corresponding EM Signal ID or after receipt of both signals in this order, then Signal Sorter Module 1000 may, at decision block 1010, determine whether Electromagnetic Signal 116 is received during transmission of the corresponding Ultrasound Signal 114 or after receipt of the corresponding Ultrasound Signal 114.

If, at decision block 1010, it is determined that Electromagnetic Signal 116 is received during transmission of Ultrasound Signal 114, then Signal Sorter Module 1000 may execute Receiver ToF Module: EM After US Transmission, But Before US Reception 1400. If, at decision block 1010, it is determined that Electromagnetic Signal 116 is received after transmission of Ultrasound Signal 114, then Signal Sorter Module 1000 may execute Beacon ToF Module: EM after US Reception 1500.

At done block 1016, Signal Sorter Module 1000 may conclude, may return to its start, or may return to a process which may have spawned it.

Receiver ToF Module: EM before US 1100 may be executed by, for example, a device in the role of Ultrasound Receiver 400. Receiver ToF Module: EM before US 1100 may be executed to determine a time-of-flight of an ultrasound signal, when a base-line temporal reference is established by transmission of an electromagnetic signal before transmission of the ultrasound signal. An example of this scenario is illustrated in FIG. 8.

At block 1102, Receiver ToF Module: EM before US 1100 may transmit Electromagnetic Signal 116 with a code, such as EM Signal ID 504, which code may have been determined by, for example, Start Session Module 900. Receiver ToF Module: EM before US 1100 may also start a timer, “timer X”, associated with EM Signal ID 504 and with a Timer 510 record. Electromagnetic Signal 116 may establish a base-line temporal reference, which may be stored as, for example, Base-Line Temporal Reference 508.

At block 1104, Receiver ToF Module: EM before US 1100 may receive or note reception of Ultrasound Signal 114, such as one sent by Beacon ToF Module: EM Before US 1200. That these signals are associated may be indicated by an associated code or identifier in Ultrasound Signal 114, which code may be decoded at block 1104 and stored as, for example, US Signal ID 506.

At block 1106, Receiver ToF Module: EM before US 1100 may determine the off-set between Base-Line Temporal Reference 508 and the time when Ultrasound Signal 114 was received, also referred to herein as second off-set, recorded in Timer 510 for timer X.

At block 1108, Receiver ToF Module: EM before US 1100 may receive communication of the first off-set, such as from Beacon ToF Module: EM Before US 1200.

At block 1110, Receiver ToF Module: EM before US 1100 may determine a time-of flight of Ultrasound Signal 114 by subtracting the first off-set from the second off-set. This may be stored in, for example, a Time-of-Flight 516 record.

At block 1112, Receiver ToF Module: EM before US 1100 may determine a distance based on the time-of flight of Ultrasound Signal 114 determined at block 1110. The distance may be determined by multiplying the time-of flight of Ultrasound Signal 114 based on the then-extant velocity of Ultrasound Signal 114 (which may be influenced by temperature, air pressure, humidity and other environmental factors which may be measured by or provided to Ultrasound Receiver 400). This may be recorded as a Distance 518 record.

At block 1114, if Receiver ToF Module: EM before US 1100 has access to more than one distance relative to more than one Beacon 200, and if the relative or absolute positions of the more than one Beacon 200 are known, then Receiver ToF Module: EM before US 1100 may bi- or trilaterate the location of Ultrasound Receiver 400 and/or of various of the more than one Beacon 200. This may be recorded as a Location 520 record.

At done block 1116, Receiver ToF Module: EM before US 1100 may conclude or return to a process which spawned it.

Beacon ToF Module: EM Before US 1200 may be executed by, for example, a device in the role of Beacon 200. Beacon ToF Module: EM Before US 1200 may be executed to facilitate determination of a time-of-flight of an ultrasound signal, when a base-line temporal reference is established by transmission of an electromagnetic signal before transmission of the ultrasound signal. An example of this scenario is illustrated in FIG. 8.

At block 1202, Beacon ToF Module: EM Before US 1200 may receive an electromagnetic signal, such as one transmitted by Ultrasound Receiver 400 executing Receiver ToF Module: EM before US 1100, which electromagnetic signal may establish a base-line temporal reference. Alternatively, Beacon ToF Module: EM Before US 1200 may transmit the electromagnetic signal to establish the base-line temporal reference.

At block 1202, Beacon ToF Module: EM Before US 1200 may start a timer, “timer Y”, which may be recorded in a Timer 308 record and which may be associated with EM Signal ID 302.

The electromagnetic signal may comprise or be associated with a code or identifier, such as EM Signal ID 504. At block 1204, Beacon ToF Module: EM Before US 1200 may decode this code and store it in Beacon Datastore 300 as EM Signal ID 302. Based on the code and/or based on the absence of a preceding associated ultrasound signal, Beacon ToF Module: EM Before US 1200 may determine that the electromagnetic signal established a base-line temporal reference. At block 1204, Beacon ToF Module: EM Before US 1200 may create a record regarding the base-line temporal reference and store such record as a Base-Line Temporal Reference 304 record. At block 1204, Beacon ToF Module: EM Before US 1200 may also wait a variable time period, generally on the order of milliseconds or seconds.

At block 1206, Beacon ToF Module: EM Before US 1200 may transmit ultrasound signal, such as Ultrasound Signal 114. Beacon ToF Module: EM Before US 1200 may encode a code in Ultrasound Signal 114, such that Ultrasound Receiver 400 and Receiver ToF Module: EM before US 1100 can readily identify Ultrasound Signal 114 as being associated with EM Signal ID 504. At block 1206, Beacon ToF Module: EM Before US 1200 may also end timer Y, and record the span of time in Timer 308 record.

At block 1208, Beacon ToF Module: EM Before US 1200 may determine a first off-set, which is the delta between the start of timer Y and ultrasound signal transmission time, recorded in Timer 308. Beacon ToF Module: EM Before US 1200 may store this as a US Transmit Off-Set 310 record.

At block 1210, Beacon ToF Module: EM Before US 1200 may communicate the delta between the start of timer Y and ultrasound signal transmission time, US Transmit Off-Set 310 record. This communication may be accomplished via any available wireless or wireline media, such as an electromagnetic signal (though without a code to identify it as establishing a base-line temporal reference). This communication may be directed to Ultrasound Receiver 400 and Receiver ToF Module: EM before US 1100 or it may be directed to any listening device.

At done block 1212, Beacon ToF Module: EM Before US 1200 may conclude or return to a process which may have spawned it.

Beacon ToF Module: EM After US Transmission, But Before US Reception 1300 may be executed by, for example, a device in the role of Beacon 200. Beacon ToF Module: EM After US Transmission, But Before US Reception 1300 may be executed to facilitate determination of a time-of-flight of an ultrasound signal, when a base-line temporal reference is established by transmission of an electromagnetic signal after transmission of the ultrasound signal. An example of this scenario is illustrated in FIG. 7.

At block 1302, Beacon ToF Module: EM After US Transmission, But Before US Reception 1300 may transmit an ultrasound signal, such as Ultrasound Signal 114. Beacon ToF Module: EM After US Transmission, But Before US Reception 1300 may do so after it or another module, such as Start Session Module 900, determines an identifying code, which identifying code may be stored as, for example, US Signal ID 306 and which identifying code may be encoded into Ultrasound Signal 114.

At block 1302, Beacon ToF Module: EM After US Transmission, But Before US Reception 1300 may also start “timer Y”, which may be recorded in a Timer 308 record and which may be associated with US Signal ID 306.

At block 1304, Beacon ToF Module: EM After US Transmission, But Before US Reception 1300 may transmit an electromagnetic signal, such as Electromagnetic Signal 116, to establish base-line temporal reference. Before doing so, Beacon ToF Module: EM After US Transmission, But Before US Reception 1300 or another module, such as Start Session Module 900, may determine a code to identify Electromagnetic Signal 116 as establishing base-line temporal reference. The code may be stored in, for example, EM Signal ID 302 and/or Base-Line Temporal Reference 304 records. The code may be encoded into Electromagnetic Signal 116. At block 1304, Beacon ToF Module: EM After US Transmission, But Before US Reception 1300 may create a Base-Line Temporal Reference 304 record to record initiation of the base-line temporal reference and Beacon ToF Module: EM After US Transmission, But Before US Reception 1300 may end timer Y and record the span of time in Timer 308 record.

At block 1306, Beacon ToF Module: EM After US Transmission, But Before US Reception 1300 may determine a first off-set, which is the delta between ultrasound signal transmission time, recorded with the start of timer Y, and the electromagnetic signal transmission time. Beacon ToF Module: EM After US Transmission, But Before US Reception 1300 may record this as a US Transmit Off-Set 310 record.

At block 1308, Beacon ToF Module: EM After US Transmission, But Before US Reception 1300 may communicate the value of the first off-set. This may occur with the transmission of Electromagnetic Signal 116 at block 1304 (such as at item 704 in FIG. 7), or it may occur separately and in a different media, such as a wireline or wireless media (such as at item 708 in FIG. 7).

At done block 1310, Beacon ToF Module: EM After US Transmission, But Before US Reception 1300 may conclude and/or return to a process which may have spawned it.

Receiver ToF Module: EM After US Transmission, But Before US Reception 1400 may be executed by, for example, a device in the role of Ultrasound Receiver 400. Receiver ToF Module: EM After US Transmission, But Before US Reception 1400 may be executed to determine a time-of-flight of an ultrasound signal, when a base-line temporal reference is established by transmission of an electromagnetic signal after transmission of the ultrasound signal, but before the ultrasound signal is received. An example of this scenario is illustrated in FIG. 7.

At block 1402, Receiver ToF Module: EM After US Transmission, But Before US Reception 1400 may receive an electromagnetic signal such as one transmitted by Beacon ToF Module: EM After US Transmission, But Before US Reception 1300 at block 1304, such as Electromagnetic Signal 116, noted at item 704 in FIG. 7.

At block 1402, Receiver ToF Module: EM After US Transmission, But Before US Reception 1400 may also start a timer, “timer X”, which may be stored as, for example, Timer 510.

At block 1404, Receiver ToF Module: EM After US Transmission, But Before US Reception 1400 may also decode an identifier or code in the received electromagnetic signal, which identifier may be stored as, for example, EM Signal ID 504. The identifier or code may identify the signal as a base-line temporal reference, which may be stored as or associated with a Base-Line Temporal Reference 508 record. EM Signal ID 504 may be associated with Timer 510.

At block 1406, Receiver ToF Module: EM After US Transmission, But Before US Reception 1400 may receive an ultrasound signal, such as one transmitted by Beacon ToF Module: EM After US Transmission, But Before US Reception 1300 at block 1302, such as Ultrasound Signal 114, noted at item 706 in FIG. 7. At block 1406, Receiver ToF Module: EM After US Transmission, But Before US Reception 1400 may decode a code or identifier in Ultrasound Signal 114, which code or identifier may be associated with EM Signal ID 504. At block 1406, Receiver ToF Module: EM After US Transmission, But Before US Reception 1400 may also end timer X.

At block 1408, Receiver ToF Module: EM After US Transmission, But Before US Reception 1400 may determine a second off-set, the delta between ultrasound reception time and start of timer X.

At block 1410, Receiver ToF Module: EM After US Transmission, But Before US Reception 1400 may receive a communication with the value of a first off-set, as may have been communicated by Beacon ToF Module: EM After US Transmission, But Before US Reception 1300 at block 1306, noted at item 704 or item 708 in FIG. 7.

At block 1412, Receiver ToF Module: EM After US Transmission, But Before US Reception 1400 may determine a time-of flight of Ultrasound Signal 114 by adding the first off-set and the second off-set.

At block 1414, Receiver ToF Module: EM After US Transmission, But Before US Reception 1400 may determine a distance based on the time-of flight of Ultrasound Signal 114 determined at block 1410. The distance may be determined by multiplying the time-of flight of Ultrasound Signal 114 based on the then-extant velocity of Ultrasound Signal 114 (which may be influenced by temperature, air pressure, humidity and other environmental factors). This may be recorded as a Distance 518 record.

At block 1416, if Receiver ToF Module: EM After US Transmission, But Before US Reception 1400 has access to more than one distance relative to more than one Beacon 200, and if the relative or absolute positions of the more than one Beacon 200 are known, then Receiver ToF Module: EM After US Transmission, But Before US Reception 1400 may bi- or trilaterate the location of Ultrasound Receiver 400 and/or of various of the more than one Beacon 200. This may be recorded as a Location 520 record.

At done block 1418, Receiver ToF Module: EM After US Transmission, But Before US Reception 1400 may conclude or return to a process which may have spawned it.

Beacon ToF Module: EM after US Reception 1500 may be executed by, for example, a device in the role of Beacon 200. Beacon ToF Module: EM after US Reception 1500 may be executed to facilitate determination of a time-of-flight of an ultrasound signal, when a base-line temporal reference is established by transmission of an electromagnetic signal after transmission and reception of the ultrasound signal. An example of this scenario is illustrated in FIG. 6.

At block 1502, Beacon ToF Module: EM after US Reception 1500 may transmit an ultrasound signal, such as Ultrasound Signal 114. Beacon ToF Module: EM after US Reception 1500 may do so after determining an identifying code, which identifying code may be stored as, for example, US Signal ID 306 and which identifying code may be encoded into Ultrasound Signal 114. Such a code may be determined by, for example, Start Session Module 900

At block 1502, Beacon ToF Module: EM after US Reception 1500 may also start “timer Y”, which may be recorded in a Timer 308 record and which may be associated with US Signal ID 306.

At block 1504, Beacon ToF Module: EM after US Reception 1500 may transmit an electromagnetic signal which establishes base-line temporal reference. Before doing so, Beacon ToF Module: EM after US Reception 1500 may encode into the electromagnetic signal a code or identifier identifying the electromagnetic signal as establishing base-line temporal reference. The identifier or code may be stored in, for example, EM Signal ID 302 and/or Base-Line Temporal Reference 304 records. Such a code may be created by, for example, Start Session Module 900 as executed by Beacon 200. Such code may be associated with US Signal ID 306.

At block 1506, Beacon ToF Module: EM after US Reception 1500 may determine a first off-set, which is the delta between ultrasound signal transmission time, recorded with the start of timer Y, and the base-line temporal reference reception time. Beacon ToF Module: EM after US Reception 1500 may record this as a US Transmit Off-Set 310 record.

At block 1508, Beacon ToF Module: EM after US Reception 1500 may communicate the value of the first off-set. This may be accomplished through various media, such as a wireline or wireless media (such as at item 708 in FIG. 7).

At done block 1510, Beacon ToF Module: EM after US Reception 1500 may conclude and/or return to a process which may have spawned it.

Receiver ToF Module: EM After US Reception 1600 may be executed by, for example, a device in the role of Ultrasound Receiver 400. Receiver ToF Module: EM After US Transmission, But Before US Reception 1400 may be executed to determine a time-of-flight of an ultrasound signal, when a base-line temporal reference is established by transmission of an electromagnetic signal after transmission of the ultrasound signal, but before the ultrasound signal is received. An example of this scenario is illustrated in FIG. 6.

At block 1602, Receiver ToF Module: EM After US Reception 1600 may optionally request an ultrasound signal. This request may be made via various media, such as wireless or wireline media, or via presence in a location proximate to Beacon 200.

At block 1604, Receiver ToF Module: EM After US Reception 1600 may receive an ultrasound signal, such as one transmitted by Beacon ToF Module: EM after US Reception 1500 at block 1502, such as Ultrasound Signal 114. The ultrasound signal transmission time by Beacon 200 is noted at ultrasound transmission time 602 and the ultrasound signal reception time by Ultrasound Receiver 400 is noted at item 604 in FIG. 6.

At block 1604, Receiver ToF Module: EM After US Reception 1600 may also start timer X and record timer X in a Timer 510 record.

At block 1606, Receiver ToF Module: EM After US Reception 1600 may decode an identifier or code in the ultrasound signal, which may be stored as, for example, US Signal ID 506.

At block 1608, Receiver ToF Module: EM After US Reception 1600 may receive an electromagnetic signal, such as one transmitted by Beacon ToF Module: EM after US Reception 1500 at block 1504, such as Electromagnetic Signal 116.

In block 1608, Receiver ToF Module: EM After US Reception 1600 may also decode an identifier or code in Electromagnetic Signal 116, which identifies it as a base-line temporal reference associated with US Signal ID 506. The identifier or code may be stored as, for example, EM Signal ID 504 and may be stored as or associated with a Base-Line Temporal Reference 508 record. EM Signal ID 504 may also be associated with Timer 510 record created at block 1604.

Upon determining via the identifier or code that the electromagnetic signal is a base-line temporal reference associated with US Signal ID 506, Receiver ToF Module: EM After US Reception 1600 may determine the period of time which elapsed between the start of timer X and reception of Electromagnetic Signal 116, which value may be recorded in Timer 510 record.

At block 1610, Receiver ToF Module: EM After US Reception 1600 may determine a second off-set, the delta between ultrasound reception time and start of timer X, the value recorded in Timer 510 record.

At block 1612, Receiver ToF Module: EM After US Reception 1600 may receive a communication with the value of a first off-set, as may have been communicated by Beacon ToF Module: EM after US Reception 1500 at block 1508, noted at item 612 or first off-set communication time 610 in FIG. 6.

At block 1614, Receiver ToF Module: EM After US Reception 1600 may determine a time-of flight of Ultrasound Signal 114 by subtracting the first off-set from the second off-set.

At block 1616, Receiver ToF Module: EM After US Reception 1600 may determine a distance based on the time-of flight of Ultrasound Signal 114 determined at block 1614. The distance may be determined by multiplying the time-of flight of Ultrasound Signal 114 based on the then-extant velocity of Ultrasound Signal 114 (which may be influenced by temperature, air pressure, humidity and other environmental factors). The determined distance may be recorded as a Distance 518 record.

At block 1618, if Receiver ToF Module: EM After US Reception 1600 has access to more than one distance relative to more than one Beacon 200, and if the relative or absolute positions of the more than one Beacon 200 are known, then Receiver ToF Module: EM After US Reception 1600 may bi- or trilaterate the location of Ultrasound Receiver 400 and/or of various of the more than one Beacon 200. This may be recorded as a Location 520 record.

At done block 1620, Receiver ToF Module: EM After US Reception 1600 may conclude or return to a process which may have spawned it.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques. Particular examples of embodiments, described herein include, but are not limited to, the following:

### Example 1

An apparatus for determining a time-of-flight for an ultrasound signal, the apparatus comprising: an ultrasound receiving device; wherein the ultrasound receiving device is to, with respect to a base-line temporal reference established by transmission of an electromagnetic signal at an electromagnetic signal transmission time: receive an ultrasound signal at an ultrasound reception time, receive a first off-set between the base-line temporal reference and the ultrasound signal transmission time, determine a second off-set between the base-line temporal reference and the ultrasound reception time, determine the time-of-flight for the ultrasound signal based on the first off-set and the second off-set; wherein the electromagnetic signal and the ultrasound signal are not transmitted simultaneously.

### Example 2

The apparatus of example 1, wherein the electromagnetic signal transmission time is before the ultrasound signal transmission time.

### Example 3

The apparatus of example 2, wherein the ultrasound receiving device is further to determine the time-of-flight for the ultrasound signal based on the first off-set and second off-set by subtracting the first off-set from the second off-set.

### Example 4

The apparatus of example 1, wherein the ultrasound receiving device is further to transmit the electromagnetic signal.

### Example 5

The apparatus of example 1, wherein the electromagnetic signal transmission time is after the ultrasound signal transmission time.

### Example 6

The apparatus of example 5, wherein determine the time-of-flight for the ultrasound signal based on the first off-set and second off-set comprises subtract the second off-set from the first off-set.

### Example 7

The apparatus of example 1, wherein a data conveyed by the electromagnetic signal comprises the first off-set.

### Example 8

The apparatus of example 5, wherein the electromagnetic signal transmission time is after the ultrasound signal transmission time and before the ultrasound reception time, and wherein determine the time-of-flight for the ultrasound signal based on the first and second off-sets comprises adding the first off-set to the second off-set.

### Example 9

The apparatus of example 1, wherein the electromagnetic signal communicates an electromagnetic signal identifier and the ultrasound signal communicates an ultrasound signal identifier.

### Example 10

The apparatus of example 9, wherein the ultrasound receiving device is further to determine an order of the signals based on the electromagnetic signal identifier and the ultrasound signal identifier.

### Example 11

The apparatus of example 1, further comprising an ultrasound transmitting device, which ultrasound transmitting device is to transmit the ultrasound signal at the ultrasound signal transmission time and is to transmit the first off-set.

### Example 12

The apparatus of example 11, wherein the ultrasound transmitting device is to determine the first off-set by measuring an elapsed time between the electromagnetic signal and the ultrasound signal transmission time.

### Example 13

The apparatus of example 11, wherein the electromagnetic signal to establish the base-line temporal reference is transmitted by one of the ultrasound transmitting device or ultrasound receiving device to many computing devices of the other type.

### Example 14

The apparatus of example 11, wherein the first off-set is transmitted at a time other than the electromagnetic signal transmission time.

### Example 15

The apparatus of example 1, wherein the ultrasound receiving device is a first ultrasound receiving device, the ultrasound reception time is a first ultrasound reception time and further comprising a second ultrasound reception device, which second ultrasound reception ultrasound receiving device is to receive the ultrasound signal at a second ultrasound reception time, determine a third off-set between the base-line temporal reference and the second ultrasound reception time, determine a third off-set between the base-line temporal reference and the second ultrasound reception time; and determining the time-of-flight for the ultrasound signal based on the first off-set and the third off-set.

### Example 16

An apparatus for enabling determination of a time-of-flight for an ultrasound signal, the apparatus comprising: an ultrasound transmitting device; wherein the ultrasound transmitting device is to, with respect to a base-line temporal reference established by transmission of an electromagnetic signal at an electromagnetic signal transmission time: transmit an ultrasound signal at an ultrasound signal transmission time, determine a first off-set between the base-line temporal reference and the ultrasound signal transmission time, transmit the first off-set; wherein the electromagnetic signal and the ultrasound signal are not transmitted simultaneously.

### Example 17

The apparatus of example 16, wherein the electromagnetic signal transmission time is before the ultrasound signal transmission time.

### Example 18

The apparatus of example 16, wherein the ultrasound transmitting device is further to determine the first off-set by measuring an elapsed time between the electromagnetic signal and the ultrasound signal transmission time.

### Example 19

The apparatus of example 16, wherein the electromagnetic signal is transmitted by the ultrasound transmitting device.

### Example 20

The apparatus of example 16, wherein the electromagnetic signal is transmitted by an ultrasound receiving device.

### Example 21

The apparatus of example 16, wherein the electromagnetic signal transmission time is after the ultrasound signal transmission time.

### Example 22

The apparatus of example 21, wherein determine the first off-set between the base-line temporal reference and the ultrasound signal transmission time comprises measure an elapsed time between the ultrasound signal transmission time and electromagnetic signal transmission time.

### Example 23

The apparatus of example 22, wherein a data conveyed by the electromagnetic signal comprises the first off-set.

### Example 24

The apparatus of example 21, wherein the electromagnetic signal transmission time is after the ultrasound signal transmission time and before the ultrasound reception time.

### Example 25

The apparatus of example 16, wherein the electromagnetic signal communicates an electromagnetic signal identifier and the ultrasound signal communicates an ultrasound signal identifier.

### Example 26

The apparatus of example 25, wherein the ultrasound transmitting device is further to determine an order of the signals based on the electromagnetic signal identifier and the ultrasound signal identifier.

### Example 27

The apparatus of example 16 to example 26, wherein the first off-set is transmitted at a time other than the electromagnetic signal transmission time.

### Example 28

A method of determining a time-of-flight for an ultrasound signal, the method comprising: with respect to a base-line temporal reference established by transmission of an electromagnetic signal at an electromagnetic signal transmission time; with an ultrasound receiving device, receiving an ultrasound signal at an ultrasound reception time; with the ultrasound receiving device, receiving a first off-set between the base-line temporal reference and an ultrasound signal transmission time with the ultrasound receiving device, determining a second off-set between the base-line temporal reference and the ultrasound reception time; with the ultrasound receiving device, determining the time-of-flight for the ultrasound signal based on the first off-set and the second off-set; and wherein the electromagnetic signal and the ultrasound signal are not transmitted simultaneously.

### Example 29

The method of example 28, wherein the electromagnetic signal transmission time is before the ultrasound signal transmission time.

### Example 30

The method of example 28, wherein determining the time-of-flight for the ultrasound signal based on the first off-set and second off-set comprises subtracting the first off-set from the second off-set.

### Example 31

The method of example 28, wherein the electromagnetic signal is transmitted by the ultrasound receiving device.

### Example 32

The method of example 28, wherein the electromagnetic signal transmission time is after the ultrasound signal transmission time.

### Example 33

The method of example 32, wherein determining the time-of-flight for the ultrasound signal based on the first off-set and second off-set comprises subtracting the second off-set from the first off-set.

### Example 34

The method of example 32, wherein the first off-set between the base-line temporal reference and the ultrasound signal transmission time is determined by measuring an elapsed time between the ultrasound signal transmission time and electromagnetic signal transmission time.

### Example 35

The method of example 34, wherein a data conveyed by the electromagnetic signal comprises the first off-set.

### Example 36

The method of example 32, wherein the electromagnetic signal transmission time is after the ultrasound signal transmission time and before the ultrasound reception time, and wherein determining the time-of-flight for the ultrasound signal based on the first and second off-sets comprises adding the first off-set to the second off-set.

### Example 37

The method of example 28, wherein the electromagnetic signal communicates an electromagnetic signal identifier and the ultrasound signal communicates an ultrasound signal identifier.

### Example 38

The method of example 37, further comprising determining an order of the signals based on the electromagnetic signal identifier and the ultrasound signal identifier.

### Example 39

The method of example 28, further comprising, with an ultrasound transmitting device, transmitting the ultrasound signal at the ultrasound signal transmission time and transmitting the first off-set.

### Example 40

The method of example 28, wherein the first off-set is determined by the ultrasound transmitting device measuring an elapsed time between the electromagnetic signal and the ultrasound signal transmission time.

### Example 41

The method of example 39, wherein the electromagnetic signal to establish the base-line temporal reference is transmitted by one of the ultrasound transmitting device or ultrasound receiving device to many computing devices of the other type.

### Example 42

The method of example 39, wherein the first off-set is transmitted at a time other than the electromagnetic signal transmission time.

### Example 43

The method of example 28, wherein the ultrasound receiving device is a first ultrasound receiving device, the ultrasound reception time is a first ultrasound reception time and further comprising, with a second ultrasound reception device, receiving the ultrasound signal at a second ultrasound reception time; with the second ultrasound reception device, determining a third off-set between the base-line temporal reference and the second ultrasound reception time; with the second ultrasound reception device, determining the time-of-flight for the ultrasound signal based on the first off-set and the third off-set.

### Example 44

A method for enabling determination of a time-of-flight for an ultrasound signal, the method comprising: with respect to a base-line temporal reference established by transmission of an electromagnetic signal at an electromagnetic signal transmission time; with an ultrasound transmitting device, transmitting an ultrasound signal at an ultrasound signal transmission time; with the ultrasound transmitting device, transmitting a first off-set between the base-line temporal reference and the ultrasound signal transmission time; wherein the electromagnetic signal and the ultrasound signal are not transmitted simultaneously.

### Example 45

The method of example 44, wherein the electromagnetic signal transmission time is before the ultrasound signal transmission time.

### Example 46

The method of example 44, wherein the first off-set is determined by measuring an elapsed time between the electromagnetic signal and the ultrasound signal transmission time.

### Example 47

The method of example 44, wherein the electromagnetic signal is transmitted by the ultrasound transmitting device.

### Example 48

The method of example 44, wherein the electromagnetic signal is transmitted by an ultrasound receiving device.

### Example 49

The method of example 44, wherein the electromagnetic signal transmission time is after the ultrasound signal transmission time.

### Example 50

The method of example 49, wherein the first off-set between the base-line temporal reference and the ultrasound signal transmission time is determined by measuring an elapsed time between the ultrasound signal transmission time and electromagnetic signal transmission time.

### Example 51

The method of example 50, wherein a data conveyed by the electromagnetic signal comprises the first off-set.

### Example 52

The method of example 49, wherein the electromagnetic signal transmission time is after the ultrasound signal transmission time and before the ultrasound reception time.

### Example 53

The method of example 44, wherein the electromagnetic signal communicates an electromagnetic signal identifier and the ultrasound signal communicates an ultrasound signal identifier.

### Example 54

The method of example 53, further comprising determining an order of the signals based on the electromagnetic signal identifier and the ultrasound signal identifier.

### Example 55

The method of example 44 to example 54, wherein the electromagnetic signal to establish the base-line temporal reference is transmitted by one of the ultrasound transmitting device or ultrasound receiving device to many computing devices of the other type.

### Example 56

The method of example 44 to example 54, wherein the first off-set is transmitted at a time other than the electromagnetic signal transmission time.

### Example 57

A system to determine a time-of-flight for an ultrasound signal between an ultrasound transmitting device and an ultrasound receiving device, the system comprising: a ultrasound transmitting device comprising an electromagnetic transceiver and an ultrasound transceiver; a ultrasound receiving device comprising an electromagnetic transceiver and an ultrasound transceiver; wherein the ultrasound transmitting device or ultrasound receiving device are to establish a base-line temporal reference by transmitting an electromagnetic signal at an electromagnetic signal transmission time; wherein the ultrasound transmitting device is to transmit an ultrasound signal at an ultrasound signal transmission time; wherein the ultrasound transmitting device is to transmit a first off-set between the base-line temporal reference and the ultrasound signal transmission time; wherein the ultrasound receiving device is to receive the ultrasound signal at an ultrasound reception time; wherein the ultrasound receiving device is to determine a second off-set between the base-line temporal reference and the ultrasound reception time; wherein the ultrasound receiving device is to determine the time-of-flight for the ultrasound signal based on the first off-set and the second off-set; and wherein the electromagnetic signal and the ultrasound signal are not transmitted simultaneously.

### Example 58

The system of example 57, wherein the electromagnetic signal transmission time is before the ultrasound signal transmission time.

### Example 59

The system of example 57, wherein the ultrasound transmitting device is to determine the first off-set by measuring an elapsed time between the electromagnetic signal and the ultrasound signal transmission time.

### Example 60

The system of example 57, wherein determining the ultrasound receiving device is to determine the time-of-flight for the ultrasound signal based on the first off-set and second off-set by subtracting the first off-set from the second off-set.

### Example 61

The system of example 57, wherein the electromagnetic signal is transmitted by the ultrasound receiving device.

### Example 62

The system of example 57, wherein the electromagnetic signal is transmitted by the ultrasound transmitting device.

### Example 63

The system of example 57, wherein the electromagnetic signal transmission time is after the ultrasound signal transmission time.

### Example 64

The system of example 63, wherein the ultrasound receiving device is to determine the time-of-flight for the ultrasound signal based on the first and second off-sets by subtracting the second off-set from the first off-set.

### Example 65

The system of example 63, wherein the ultrasound transmitting device is to determine the first off-set between the base-line temporal reference and the ultrasound signal transmission time by measuring an elapsed time between the ultrasound signal transmission time and electromagnetic signal transmission time.

### Example 66

The system of example 65, wherein a data conveyed by the electromagnetic signal comprises the first off-set.

### Example 67

The system of example 63, wherein the electromagnetic signal transmission time is after the ultrasound signal transmission time and before the ultrasound reception time, and wherein the ultrasound receiving device determines the time-of-flight for the ultrasound signal based on the first and second off-sets by adding the first off-set to the second off-set.

### Example 68

The system of example 57, wherein the electromagnetic signal communicates an electromagnetic signal identifier and the ultrasound signal communicates an ultrasound signal identifier.

### Example 69

The system of example 68, wherein the first and second computing devices are further to determine an order of the signals based on the electromagnetic signal identifier and the ultrasound signal identifier.

### Example 70

The system of example 57 to example 69, wherein the ultrasound transmitting device or ultrasound receiving device is to establish the base-line temporal reference by transmitting the electromagnetic signal to many computing devices of the other type.

### Example 71

The system of example 57 to example 69, wherein the first off-set is transmitted at a time other than the electromagnetic signal transmission time.

### Example 72

The system of example 57, wherein the ultrasound reception time is a first ultrasound reception time and further comprising second ultrasound reception device, which second ultrasound reception device is to receive the ultrasound signal at a second ultrasound reception time; wherein the second ultrasound reception device is to determine a third off-set between the base-line temporal reference and the second ultrasound reception time; wherein the second ultrasound reception device is to determine the time-of-flight for the ultrasound signal based on the first off-set and the third off-set.

### Example 73

A system for determining a time-of-flight for an ultrasound signal between an ultrasound transmitting device and an ultrasound receiving device, the system comprising: means for, with the ultrasound transmitting device or ultrasound receiving device, establishing a base-line temporal reference by transmitting an electromagnetic signal at an electromagnetic signal transmission time; means for, with the ultrasound transmitting device, transmitting an ultrasound signal at an ultrasound signal transmission time; means for, with the ultrasound transmitting device, transmitting a first off-set between the base-line temporal reference and the ultrasound signal transmission time; means for, with the ultrasound receiving device, receiving the ultrasound signal at an ultrasound reception time; means for, with the ultrasound receiving device, determining a second off-set between the base-line temporal reference and the ultrasound reception time; means for, with the ultrasound receiving device, determining the time-of-flight for the ultrasound signal based on the first off-set and the second off-set; and wherein the electromagnetic signal and the ultrasound signal are not transmitted simultaneously.

### Example 74

The system of example 73, wherein the electromagnetic signal transmission time is before the ultrasound signal transmission time.

### Example 75

The system of example 73, wherein means for determining the first off-set comprises means for measuring an elapsed time between the electromagnetic signal and the ultrasound signal transmission time.

### Example 76

The system of example 73, wherein means for determining the time-of-flight for the ultrasound signal based on the first off-set and second off-set comprises means for subtracting the first off-set from the second off-set.

### Example 77

The system of example 73, wherein the electromagnetic signal is transmitted by the ultrasound receiving device.

### Example 78

The system of example 73, wherein the electromagnetic signal is transmitted by the ultrasound transmitting device.

### Example 79

The system of example 73, wherein the electromagnetic signal transmission time is after the ultrasound signal transmission time.

### Example 80

The system of example 79, wherein means for determining the time-of-flight for the ultrasound signal based on the first and second off-sets comprises means for subtracting the second off-set from the first off-set.

### Example 81

The system of example 79, wherein means for determining the first off-set between the base-line temporal reference and the ultrasound signal transmission time comprises means for measuring an elapsed time between the ultrasound signal transmission time and electromagnetic signal transmission time.

### Example 82

The system of example 81, wherein a data conveyed by the electromagnetic signal comprises the first off-set.

### Example 83

The system of example 79, wherein the electromagnetic signal transmission time is after the ultrasound signal transmission time and before the ultrasound reception time, and wherein means for determining the time-of-flight for the ultrasound signal based on the first and second off-sets comprises means for adding the first off-set to the second off-set.

### Example 84

The system of example 73, wherein the electromagnetic signal communicates an electromagnetic signal identifier and the ultrasound signal communicates an ultrasound signal identifier.

### Example 85

The system of example 84, further comprising means for determining an order of the signals based on the electromagnetic signal identifier and the ultrasound signal identifier.

### Example 86

The system of example 73 to example 85, wherein the means for transmitting the electromagnetic signal to establish the base-line temporal reference by one of the ultrasound transmitting device or ultrasound receiving device comprises means for transmitting the electromagnetic signal to establish the base-line temporal reference to more than one computing device of the other type.

### Example 87

The system of example 73 to example 85, wherein the first off-set is transmitted at a time other than the electromagnetic signal transmission time.

### Example 88

The system of example 73 to example 85, wherein the ultrasound transmitting device and ultrasound receiving device each comprise an electromagnetic transceiver and an ultrasound transceiver.

### Example 89

The system of example 73, wherein the ultrasound reception time is a first ultrasound reception time and further comprising a second ultrasound reception device and means for receiving by the second ultrasound reception device the ultrasound signal at a second ultrasound reception time; means for, with the second ultrasound reception device, determining a third off-set between the base-line temporal reference and the second ultrasound reception time; means for, with the second ultrasound reception device, determining the time-of-flight for the ultrasound signal based on the first off-set and the third off-set.

### Example 90

One or more computer readable media comprising instructions to that cause a set of computing devices, in response to execution of the instructions by one or more processors of the computing devices, to: by the ultrasound transmitting device or ultrasound receiving device, establish a base-line temporal reference by transmitting an electromagnetic signal at an electromagnetic signal transmission time; by the ultrasound transmitting device, transmit an ultrasound signal at an ultrasound signal transmission time; by the ultrasound transmitting device, transmit a first off-set between the base-line temporal reference and the ultrasound signal transmission time; by the ultrasound receiving device, receive the ultrasound signal at an ultrasound reception time; by the ultrasound receiving device, determine a second off-set between the base-line temporal reference and the ultrasound reception time; by the ultrasound receiving device, determine the time-of-flight for the ultrasound signal based on the first off-set and the second off-set; and wherein the electromagnetic signal and the ultrasound signal are not transmitted simultaneously; wherein the set of computing devices comprises an ultrasound transmitting device and an ultrasound receiving device, which computing devices each comprise an electromagnetic transceiver and an ultrasound transceiver.

### Example 91

The computer readable media of example 90, wherein the electromagnetic signal transmission time is before the ultrasound signal transmission time.

### Example 92

The computer readable media of example 90, wherein the instructions are further to cause the ultrasound transmitting device to determine the first off-set by measuring an elapsed time between the electromagnetic signal and the ultrasound signal transmission time.

### Example 93

The computer readable media of example 90, wherein the instructions are further to cause the ultrasound receiving device to determine the time-of-flight for the ultrasound signal based on the first off-set and second off-set by subtracting the first off-set from the second off-set.

### Example 94

The computer readable media of example 90, wherein the instructions are further to cause the ultrasound receiving device to transmit the electromagnetic signal.

### Example 95

The computer readable media of example 90, wherein the electromagnetic signal transmission time is after the ultrasound signal transmission time.

### Example 96

The computer readable media of example 95, wherein the instructions are further to cause the ultrasound receiving device to determine the time-of-flight for the ultrasound signal based on the first and second off-sets by subtracting the second off-set from the first off-set.

### Example 97

The computer readable media of example 95, wherein the instructions are further to cause the ultrasound transmitting device to determine the first off-set between the base-line temporal reference and the ultrasound signal transmission time by measuring an elapsed time between the ultrasound signal transmission time and electromagnetic signal transmission time.

### Example 98

The computer readable media of example 97, wherein a data conveyed by the electromagnetic signal comprises the first off-set.

### Example 99

The computer readable media of example 95, wherein the electromagnetic signal transmission time is after the ultrasound signal transmission time and before the ultrasound reception time, and wherein the instructions are further to cause the ultrasound receiving device to determine the time-of-flight for the ultrasound signal based on the first and second off-sets by adding the first off-set to the second off-set.

### Example 100

The computer readable media of example 90, wherein the electromagnetic signal communicates an electromagnetic signal identifier and the ultrasound signal communicates an ultrasound signal identifier.

### Example 101

The computer readable media of example 100, wherein the instructions are further to cause the first and second computing devices to determine an order of the signals based on the electromagnetic signal identifier and the ultrasound signal identifier.

### Example 102

The computer readable media of example 90 to example 101, wherein the instructions are further to cause the ultrasound transmitting device or ultrasound receiving device to establish the base-line temporal reference by transmitting the electromagnetic signal to many computing devices of the other type.

### Example 103

The computer readable media of example 90 to example 101, wherein the instructions are further to cause the first off-set to be transmitted at a time other than the electromagnetic signal transmission time.

### Example 104

The computer readable media of example 90, wherein the ultrasound reception time is a first ultrasound reception time, further comprising a second ultrasound reception device, wherein the instructions are further to cause the second ultrasound reception device to receive the ultrasound signal at a second ultrasound reception time; wherein the instructions are further to cause the second ultrasound reception device to determine a third off-set between the base-line temporal reference and the second ultrasound reception time; wherein the instructions are further to cause the second ultrasound reception device to determine the time-of-flight for the ultrasound signal based on the first off-set and the third off-set.

What is claimed is:

1. An apparatus equipped to determine a time-of-flight for an ultrasound signal, the apparatus comprising:
an ultrasound receiver; and a controlling module coupled to the ultrasound receiver;
wherein the ultrasound receiver is to, with respect to a base-line temporal reference established by transmission of an electromagnetic signal at an electromagnetic signal transmission time:
receive the ultrasound signal at an ultrasound reception time, and receive a first off-set between the base-line temporal reference and an ultrasound signal transmission time; and
wherein the controlling module is to
determine a second off-set between the base-line temporal reference and the ultrasound reception time, and determine the time-of-flight for the ultrasound signal based on the first off-set and the second off-set;
wherein the electromagnetic signal and the ultrasound signal are not transmitted simultaneously.

2. The apparatus of claim 1, wherein the electromagnetic signal transmission time is before the ultrasound signal transmission time.

3. The apparatus of claim 2, wherein the controlling module is further to determine the time-of-flight for the ultrasound signal based on the first off-set and the second off-set by subtracting the first off-set from the second off-set.

4. The apparatus of claim 1, further comprising an electromagnetic transceiver to transmit the electromagnetic signal.

5. The apparatus of claim 1, wherein the electromagnetic signal is to communicate an electromagnetic signal identifier and the ultrasound signal is to communicate an ultrasound signal identifier and wherein the controlling module is further to determine an association between the electromagnetic signal and the ultrasound signal based on the electromagnetic signal identifier and the ultrasound signal identifier.

6. The apparatus of claim 1, wherein the ultrasound receiver is a first ultrasound receiver, the ultrasound reception time is a first ultrasound reception time and the apparatus further comprises a second ultrasound receiver, which second ultrasound receiver is to receive the ultrasound signal at a second ultrasound reception time; and
wherein the controlling module is further to determine a third off-set between the base-line temporal reference and the second ultrasound reception time,
determine a third off-set between the base-line temporal reference and the second ultrasound reception time; and
determining the time-of-flight for the ultrasound signal based on the first off-set and the third off-set.

7. An apparatus equipped to contribute to a determination of a time-of-flight for an ultrasound signal, the apparatus comprising:
an ultrasound transmitter; and
an a controlling module coupled with the ultrasound transmitter;
wherein the ultrasound transmitter is to, with respect to a base-line temporal reference established by transmission of an electromagnetic signal at an electromagnetic signal transmission time, transmit the ultrasound signal at an ultrasound signal transmission time;
wherein the controlling module is to
determine a first off-set between the base-line temporal reference and the ultrasound signal transmission time, and
transmit the first off-set;
wherein the electromagnetic signal and the ultrasound signal are not transmitted simultaneously.

8. The apparatus of claim 7, wherein the electromagnetic signal transmission time is before the ultrasound signal transmission time.

9. The apparatus of claim 7, wherein the ultrasound transmitter is further to determine the first off-set by measuring an elapsed time between the electromagnetic signal and the ultrasound signal transmission time.

10. The apparatus of claim 7 wherein the electromagnetic signal is transmitted by the ultrasound transmitter.

11. The apparatus of claim 7, wherein the electromagnetic signal is transmitted by an ultrasound receiver.

12. The apparatus of claim 7, wherein to determine the first off-set between the base-line temporal reference and the ultrasound signal transmission time, the controlling module is to determine an elapsed time between the ultrasound signal transmission time and the electromagnetic signal transmission time.

13. A method of determining a time-of-flight for an ultrasound signal, the method comprising:
with respect to a base-line temporal reference established by transmission of an electromagnetic signal at an electromagnetic signal transmission time;
with an ultrasound receiver, receiving the ultrasound signal at an ultrasound reception time;
with the ultrasound receiver, receiving a first off-set between the base-line temporal reference and an ultrasound signal transmission time;
with the ultrasound receiver, determining a second off-set between the base-line temporal reference and the ultrasound reception time;
with the ultrasound receiver, determining the time-of-flight for the ultrasound signal based on the first off-set and the second off-set; and
wherein the electromagnetic signal and the ultrasound signal are not transmitted simultaneously.

14. The method of claim 13, wherein the electromagnetic signal transmission time is before the ultrasound signal transmission time.

15. The method of claim 14, wherein determining the time-of-flight for the ultrasound signal based on the first off-set and the second off-set comprises subtracting the first off-set from the second off-set.

16. The method of claim 13, wherein the electromagnetic signal is transmitted by the ultrasound receiver.

17. The method of claim 13, wherein the electromagnetic signal communicates an electromagnetic signal identifier and the ultrasound signal communicates an ultrasound signal identifier and further comprising determining an association between the electromagnetic signal and the ultrasound signal based on the electromagnetic signal identifier and the ultrasound signal identifier.

18. The method of claim 13, further comprising, with an ultrasound transmitter, transmitting the ultrasound signal at the ultrasound signal transmission time, determining the first off-set by measuring an elapsed time between the ultrasound signal transmission time and the electromagnetic signal transmission time, and transmitting the first off-set, wherein the first off-set is transmitted at a time other than the electromagnetic signal transmission time.

19. The method of claim 13, wherein the ultrasound receiver is a first ultrasound receiver, the ultrasound reception time is a first ultrasound reception time and further comprising, with a second ultrasound receiver, receiving the ultrasound signal at a second ultrasound reception time;
with the second ultrasound receiver, determining a third off-set between the base-line temporal reference and the second ultrasound reception time;
with the second ultrasound receiver, determining the time-of-flight for the ultrasound signal based on the first off-set and the third off-set.

20. One or more computer readable media comprising instructions that, in response to execution by an ultrasound receiver, cause the ultrasound receiver, in response to execution of the instructions by one or more processors of the ultrasound receiver, to determine a time-of-flight for an ultrasound signal with respect to a base-line temporal reference established by transmission of an electromagnetic signal at an electromagnetic signal transmission time, wherein to determine includes to:
receive the ultrasound signal at an ultrasound reception time,
receive a first off-set between the base-line temporal reference and an ultrasound signal transmission time,
determine a second off-set between the base-line temporal reference and the ultrasound reception time, and
determine the time-of-flight for the ultrasound signal based on the first off-set and the second off-set;
wherein the electromagnetic signal and the ultrasound signal are not transmitted simultaneously.

21. The computer readable media of claim 20, wherein the electromagnetic signal transmission time is after the ultrasound signal transmission time and wherein to determine the time-of-flight further comprises determine the time-of-flight for the ultrasound signal based on the first off-set and the second off-set by subtracting the second off-set from the first off-set.

22. The computer readable media of claim 20, wherein the ultrasound receiver is further caused to transmit the electromagnetic signal.

23. The computer readable media of claim 20, wherein the electromagnetic signal is to communicate an electromagnetic signal identifier and the ultrasound signal is to communicate an ultrasound signal identifier and to determine the time-of-flight further comprises to determine an association between the electromagnetic signal and the ultrasound signal based on the electromagnetic signal identifier and the ultrasound signal identifier.

24. One or more computer readable media comprising instructions that, in response to execution by an ultrasound transmitter, cause the ultrasound transmitter to contribute to determination of a time-of-flight for an ultrasound signal, with respect to a base-line temporal reference established by transmission of an electromagnetic signal at an electromagnetic signal transmission time, wherein to contribute to the determination of the time-of-flight includes to:
transmit the ultrasound signal at an ultrasound signal transmission time,
determine a first off-set between the base-line temporal reference and the ultrasound signal transmission time, and
transmit the first off-set;
wherein the electromagnetic signal and the ultrasound signal are not transmitted simultaneously.

25. The computer readable media of claim 24, wherein the electromagnetic signal transmission time is before the ultrasound signal transmission time.
